(19) United States
(12) Patent Application Publication
(10) Pub. No.: US 2025/0208390 A1
(43) Pub. Date: Jun. 26, 2025

(54) ZOOM LENS, PROJECTION TYPE DISPLAY DEVICE, AND IMAGING APPARATUS

(71) Applicant: FUJIFILM Corporation, Tokyo (JP)

(72) Inventor: Taku FURUBAYASHI, Saitama-shi (JP)

(73) Assignee: FUJIFILM Corporation, Tokyo (JP)

(21) Appl. No.: 18/970,372

(22) Filed: Dec. 5, 2024

(30) Foreign Application Priority Data
Dec. 20, 2023 (JP) 2023-215257

(51) Int. Cl. G02B 15/14; G02B 13/16

(52) U.S. Cl. CPC G02B 15/1451; G02B 13/16

(57) ABSTRACT

A zoom lens consists of a first optical system and a second optical system in order from an enlargement side to a reduction side. The second optical system forms an intermediate image at a position conjugate to a reduction-side imaging plane, and the first optical system re-forms the intermediate image on an enlargement-side imaging plane. A lens closest to the enlargement side in the second optical system is a positive lens that has a convex surface facing the enlargement side. The second optical system includes, continuously in order from a position closest to the enlargement side to the reduction side, a first movable lens group, a second movable lens group, and a third movable lens group each of which moves during changing magnification. In the entire zoom lens, lens groups that move during changing magnification are only the first to third movable lens groups.

### CROSS-REFERENCE TO RELATED APPLICATIONS

This application claims priority from Japanese Application No. 2023-215257, filed on Dec. 20, 2023, the entire disclosure of which is incorporated herein by reference.

### BACKGROUND

### Technical Field

The present disclosed technology relates to a zoom lens, a projection type display device, and an imaging apparatus.

### Related Art

As a zoom lens applicable to the projection type display device or the imaging apparatus, there is a known image forming optical system described in JP2020-052385A and JP2021-026087A.

For a zoom lens that forms an intermediate image, it has been demanded to maintain a satisfactory optical performance while having a high magnification. A level of the demand has increased year by year.

### SUMMARY

The present disclosure has been made in view of the above circumstances, and an object thereof is to provide a zoom lens that forms an intermediate image and where a satisfactory optical performance is maintained while having a high magnification, a projection type display device including the zoom lens, and an imaging apparatus including the zoom lens.

According to one aspect of the present disclosure, there is provided a zoom lens consisting of a first optical system and a second optical system along an optical path in order from an enlargement side to a reduction side, in which the second optical system forms an intermediate image at a position conjugate to a reduction-side imaging plane, and the first optical system re-forms the intermediate image on an enlargement-side imaging plane, a lens closest to the enlargement side in the second optical system is a positive lens that has a convex surface facing the enlargement side, in a case where one lens group is a group of which a spacing to an adjacent group in an optical axis direction changes during changing magnification, the second optical system includes, continuously along the optical path in order from a position closest to the enlargement side to the reduction side, a first movable lens group having a positive refractive power that moves during changing magnification, a second movable lens group that moves during changing magnification, and a third movable lens group having a positive refractive power that moves during changing magnification, and in the entire zoom lens, lens groups that move during changing magnification are only the first movable lens group, the second movable lens group, and the third movable lens group.

In the zoom lens according to the above-described aspect, it is preferable that the second optical system includes a stationary lens group that is fixed to the reduction-side imaging plane closest to the reduction side during changing magnification.

In the zoom lens according to the above-described aspect, it is preferable that the stationary lens group has a positive refractive power.

In the zoom lens according to the above-described aspect, it is preferable that the reduction side is configured to be telecentric.

In the zoom lens according to the above-described aspect, It is preferable that the second movable lens group has a negative refractive power.

In the zoom lens according to the above-described aspect, in a case where a focal length of the zoom lens at a wide angle end is represented by fw and a focal length of the first optical system is represented by fr1, it is preferable that Conditional Expression (1) is satisfied:

$$0.8 < fr 1 / \vert fw \vert < 5. \qquad ( 1 )$$

In the zoom lens according to the above-described aspect, it is preferable that the first optical system includes a cemented lens where a positive lens, a negative lens, and a positive lens are cemented in this order.

In the zoom lens according to the above-described aspect, it is preferable that an effective diameter of an enlargement-side surface of a second lens from the enlargement side in the first optical system at a wide angle end is less than an effective diameter of an enlargement-side surface of a lens closest to the reduction side in the first optical system at the wide angle end.

In the zoom lens according to the above-described aspect, it is preferable that the second movable lens group consists of one negative lens and one positive lens.

In the zoom lens according to the above-described aspect, in a case where a focal length of the first movable lens group is represented by f1, a focal length of the second movable lens group is represented by f2, and a focal length of the third movable lens group is represented by f3,
it is preferable that Conditional Expressions (2) and (3) are satisfied:

$$0 < \vert f 1 / f 2 \vert < 0.75 \qquad ( 2 )$$

$$0 < \vert f 3 / f 2 \vert < 0.75 , and \qquad ( 3 )$$

it is more preferable that Conditional Expressions (2-2) and (3-2) are satisfied:

$$0 < \vert f 1 / f 2 \vert < 0.5 \qquad ( 2 ‐ 2 )$$

$$0 < \vert f 3 / f 2 \vert < 0.5 . \qquad ( 3 ‐ 2 )$$

In the zoom lens according to the above-described aspect, in a case where a focal length of the first movable lens group is represented by f1 and a focal length of the third movable lens group is represented by f3,
it is preferable that Conditional Expression (4) is satisfied:

$$0.5 < f 1 / f 3 < 2. \qquad ( 4 )$$

In the zoom lens according to the above-described aspect, it is preferable that the first movable lens group at a telephoto end is positioned closer to the enlargement side than the first movable lens group at a wide angle end, the second movable lens group at the telephoto end is positioned closer to the enlargement side than the second movable lens group at the wide angle end, and the third movable lens group at the telephoto end is positioned closer to the enlargement side than the third movable lens group at the wide angle end.

In the zoom lens according to the above-described aspect, it is preferable that, during changing magnification from the wide angle end to the telephoto end, each of the first movable lens group, the second movable lens group, and the third movable lens group constantly moves to the enlargement side.

In the zoom lens according to the above-described aspect, it is preferable that a first optical path bending member that bends the optical path is disposed in the first optical system.

In the zoom lens according to the above-described aspect, it is preferable that a second optical path bending member that bends the optical path is disposed closer to the reduction side than the first optical system.

In the zoom lens according to the above-described aspect, it is preferable that a first optical path bending member that bends the optical path is disposed in the first optical system, and a second optical path bending member that bends the optical path is disposed closer to the reduction side than the first optical system.

In the zoom lens according to the above-described aspect, it is preferable that the first optical system has a positive refractive power and is fixed to the reduction-side imaging plane during changing magnification, and the second optical system consists of, along the optical path in order from the enlargement side to the reduction side, the first movable lens group, the second movable lens group, the third movable lens group, and a stationary lens group that is fixed to the reduction-side imaging plane during changing magnification.

According to another aspect of the present disclosure, there is provided a projection type display device comprising the zoom lens according to the above-described aspect.

According to still another aspect of the present disclosure, there is provided an imaging apparatus comprising the zoom lens according to the above-described aspect.

In the present specification, it should be noted that “consisting of” and “consists of” represents that not only the above-described components but also lenses substantially having no refractive powers, optical elements other than lenses, such as a stop, a mask, a filter, a cover glass, a planar mirror, and a prism, and mechanism parts such as a lens flange, a lens barrel, an imaging element, and a camera shaking correction mechanism may be included.

In the present specification, “group that has a positive refractive power” and “group has a positive refractive power” represents that the group as a whole has a positive refractive power. Likewise, “group that has a negative refractive power” and “group has a negative refractive power” represents that the group as a whole has a negative refractive power. “Lens group” is not limited to a configuration consisting of a plurality of lenses, but may consist of only one lens.

The number of lenses described above is the number of lenses as components. For example, it is assumed that the number of lenses in a cemented lens in which a plurality of single lenses made of different materials are cemented is represented by the number of single lenses constituting the cemented lens. Here, a compound aspherical lens (in which a lens (for example, a spherical lens) and an aspherical film formed on the lens are integrally formed and function as one aspherical lens as a whole) is not regarded as a cemented lens, but the compound aspherical lens is regarded as one lens. The sign of the refractive power, and the surface shape of the lens including the aspherical surface will be used in terms of the paraxial region unless otherwise specified.

The “focal length” used in the conditional expressions is a paraxial focal length. The values used in the conditional expression are values that are obtained with respect to the d line. The “d line”, “C line”, and “F line” described in the present specification are emission lines, the wavelength of the d line is 587.56 nanometers (nm), the wavelength of the C line is 656.27 nanometers (nm), and the wavelength of the F line is 486.13 nanometers (nm).

According to the present disclosure, it is possible to provide a zoom lens that forms an intermediate image and where a satisfactory optical performance is maintained while having a high magnification, a projection type display device including the zoom lens, and an imaging apparatus including the zoom lens.

### BRIEF DESCRIPTION OF THE DRAWINGS

FIG. 1 is a cross-sectional view corresponding to a zoom lens according to Example 1 and showing a configuration and luminous fluxes of a zoom lens according to one embodiment.

FIG. 2 is a cross-sectional view showing a configuration and luminous fluxes of the zoom lens according to Example 1 in each of zoom states.

FIG. 3 is a cross-sectional view showing a configuration and luminous fluxes of a first modification example of the zoom lens according to Example 1.

FIG. 4 is a cross-sectional view showing a configuration and luminous fluxes of a second modification example of the zoom lens according to Example 1.

FIG. 5 is a cross-sectional view showing a configuration and luminous fluxes of a third modification example of the zoom lens according to Example 1.

FIG. 6 shows each of aberration diagrams in the zoom lens according to Example 1.

FIG. 7 is a cross-sectional view showing a configuration and luminous fluxes of a zoom lens according to Example 2.

FIG. 8 is a cross-sectional view showing a configuration and luminous fluxes of a modification example of the zoom lens according to Example 2.

FIG. 9 shows each of aberration diagrams in the zoom lens according to Example 2.

FIG. 10 is a cross-sectional view showing a configuration and luminous fluxes of a zoom lens according to Example 3.

FIG. 11 is a cross-sectional view showing a configuration and luminous fluxes of a modification example of the zoom lens according to Example 3.

FIG. 12 shows each of aberration diagrams in the zoom lens according to Example 3.

FIG. 13 is a cross-sectional view showing a configuration and luminous fluxes of a zoom lens according to Example 4.

FIG. 14 is a cross-sectional view showing a configuration and luminous fluxes of a modification example of the zoom lens according to Example 4.

FIG. 15 shows each of aberration diagrams in the zoom lens according to Example 4.

FIG. 16 is a cross-sectional view showing a configuration and luminous fluxes of a zoom lens according to Example 5.

FIG. 17 is a cross-sectional view showing a configuration and luminous fluxes of a modification example of the zoom lens according to Example 5.

FIG. 18 shows each of aberration diagrams in the zoom lens according to Example 5.

FIG. 19 is a cross-sectional view showing a configuration and luminous fluxes of a zoom lens according to Example 6.

FIG. 20 is a cross-sectional view showing a configuration and luminous fluxes of a modification example of the zoom lens according to Example 6.

FIG. 21 shows each of aberration diagrams in the zoom lens according to Example 6.

FIG. 22 is a schematic configuration diagram showing a projection type display device according to an embodiment.

FIG. 23 is a schematic configuration diagram showing a projection type display device according to another embodiment.

FIG. 24 is a schematic configuration diagram showing a projection type display device according to still another embodiment.

FIG. 25 is a perspective view showing a front side of an imaging apparatus according to one embodiment.

FIG. 26 is a perspective view showing a rear side of the imaging apparatus shown in FIG. 25.

### DETAILED DESCRIPTION

Hereinafter, embodiments of the present disclosure will be described with reference to the accompanying drawings.

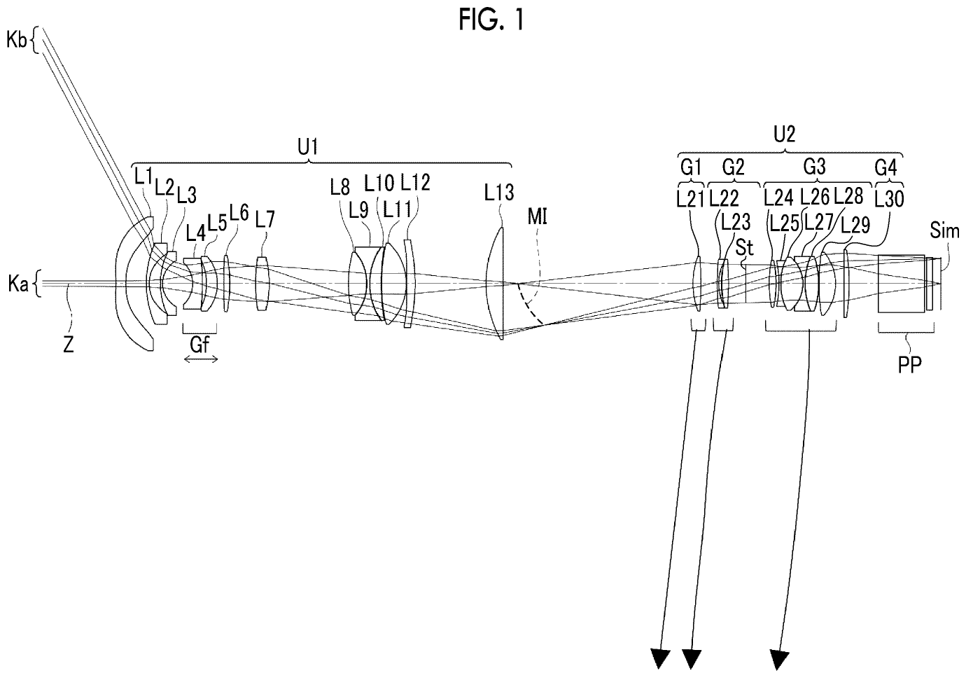

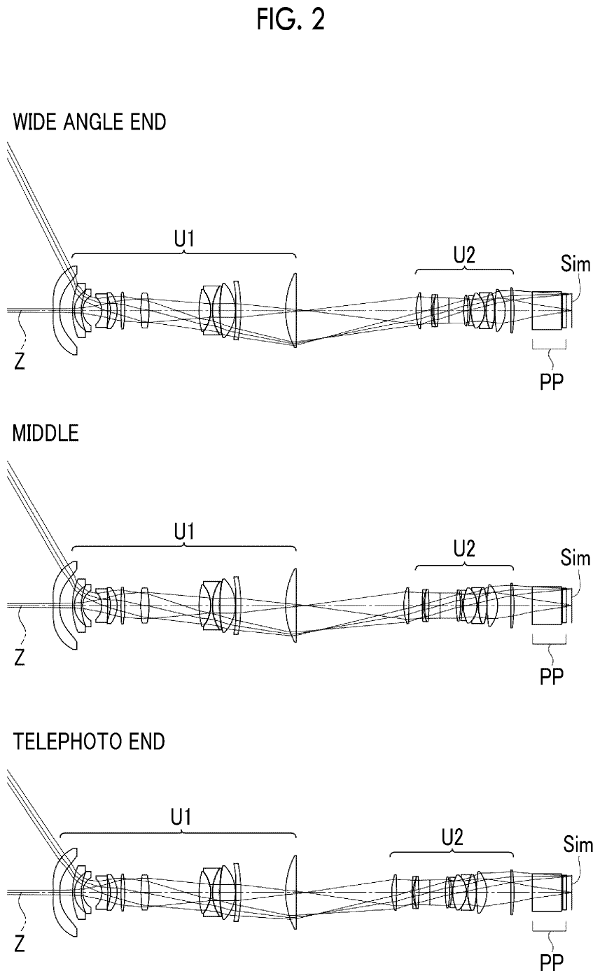

FIG. 1 is a cross-sectional view showing a configuration and luminous fluxes at a wide angle end of a zoom lens according to one embodiment of the present disclosure. As the luminous fluxes, FIG. 1 shows on-axis luminous fluxes Ka and luminous fluxes Kb with maximum angle of view. FIG. 2 is a cross-sectional view showing a configuration and luminous fluxes in each of zoom states of the zoom lens. In FIG. 2, the upper stage to which “wide angle end” is attached shows a wide angle end state, the middle stage to which “middle” is attached shows a middle focal length state, and the lower stage to which “telephoto end” is attached shows a telephoto end state. The example of FIGS. 1 and 2 corresponds to the zoom lens according to Example 1 below. In FIGS. 1 and 2, the left side is an enlargement side, and the right side is a reduction side. Hereinafter, the description will be described mainly with reference to FIG. 1.

The zoom lens according to the present disclosure may be a projection optical system that is mounted on a projection type display device and forms an image to be projected onto a screen, or may be an imaging optical system that is mounted on an imaging apparatus and forms an image of an object. Hereinafter, the case of using the zoom lens in the application of the projection optical system will be described. Further, hereinafter, “the zoom lens according to the embodiment of the present disclosure” will also be simply referred to as “the zoom lens” in order to avoid redundant description.

FIG. 1 shows an example in which an optical member PP and an image display surface Sim of a light valve are disposed on the reduction side of the zoom lens assuming that the zoom lens is mounted on the projection type display device. The optical member PP is a member which is regarded as a filter, a cover glass, a color synthesis prism, or the like. The optical member PP has no refractive power, and a configuration where the optical member PP is not provided can also be adopted. The light valve outputs an optical image, and the optical image is displayed as an image on the image display surface Sim.

In the projection type display device, a luminous flux to which image information is given on the image display surface Sim is incident on the zoom lens through the optical member PP, and is projected onto a screen (not shown) by the zoom lens. In this case, the image display surface Sim corresponds to a reduction-side imaging plane, and the screen corresponds to an enlargement-side imaging plane. In the present specification, “the screen” refers to an object onto which a projection image formed by the zoom lens is projected. The screen may be not only a dedicated screen but also a wall surface of a room, a floor surface, a ceiling, an outer wall surface of a building, or the like.

In addition, in the description of the present specification, “the enlargement side” refers to the screen side on the optical path, and the “reduction side” refers to the image display surface Sim side on the optical path. In the present specification, “the enlargement side” and “the reduction side” are determined along the optical path, and this point also applies to a zoom lens that forms a bent optical path. “Closest to the enlargement side” represents that a position is closest to the enlargement side in the arrangement order on the optical path, and does not represent that the position is closest to the screen in terms of distance. Hereinafter, in order to avoid redundant description, “along the optical path in order from the enlargement side to the reduction side” will also be referred to as “in order from the enlargement side to the reduction side”.

The zoom lens according to the present disclosure consists of a first optical system U1 and a second optical system U2 along the optical path in order from the enlargement side to the reduction side. The zoom lens of the present disclosure has a configuration where the second optical system U2 forms an intermediate image MI at a position conjugate to the reduction-side imaging plane and the first optical system U1 re-forms the intermediate image MI on the enlargement-side imaging plane. Hereinafter, among the optical systems constituting the zoom lens, an optical system closer to the enlargement side than the intermediate image MI will be referred to as the first optical system U1, and an optical system closer to the reduction side than the intermediate image MI will be referred to as the second optical system U2.

In the projection type display device, the second optical system U2 forms the intermediate image MI of an image to be displayed on the image display surface Sim, and the first optical system projects the intermediate image MI onto the screen onto form a projection image. This way, the zoom lens according to the present disclosure is configured to have the intermediate image MI. As a result, the size of the lens system can be suppressed while realizing a wide-angle projection optical system. In FIG. 1, only a part below an optical axis Z in the intermediate image MI is schematically indicated by a dotted line. The intermediate image MI in FIG. 1 shows a position in an optical axis direction and does not show an accurate shape.

A lens closest to the enlargement side in the second optical system U2 is a positive lens that has a convex surface facing the enlargement side. That is, the lens closest to the enlargement side in the second optical system U2 is a lens adjacent to the reduction side of the intermediate image MI. This lens is used as the positive lens that has a convex surface facing the enlargement side, which is advantageous in reducing the diameter of the zoom lens even in a case where a spacing between two lens surfaces between which the intermediate image MI is interposed.

The second optical system U2 includes, continuously along an optical path in order from a position closest to the enlargement side to the reduction side, a first movable lens group having a positive refractive power that moves during changing magnification, a second movable lens group that moves during changing magnification, and a third movable lens group having a positive refractive power that moves during changing magnification. The second optical system U2 includes the three lens groups that move during changing magnification, which is advantageous in obtaining a high zoom magnification. Since the second optical system U2 forms the intermediate image MI, the signs of the refractive powers of the first movable lens group and the third movable lens group are positive.

In the entire zoom lens, lens groups that move during changing magnification are only the first movable lens group, the second movable lens group, and the third movable lens group. In the entire zoom lens, by using only the three lens groups as the lens groups that move during changing magnification, a magnification changing mechanism can be avoided from being complicated. In addition, the three lens groups that move during changing magnification are continuously disposed along the optical path in this order, which is advantageous in reducing the total optical length.

In the present specification, one lens group is a group of which a spacing to an adjacent group in the optical axis direction changes during changing magnification. That is, “lens group” in the present specification is a component part of the zoom lens, and is a part that is divided by an air spacing that changes during changing magnification and that includes at least one lens. During changing magnification, each of the lens group units moves or is fixed, and a mutual spacing between the lenses in each of the lens groups does not change. “Lens group” may include components having no refractive power other than the lenses, for example, a stop, a mask, a filter, a cover glass, a planar mirror, and a prism.

For example, the zoom lens of FIG. 1 consists of the first optical system U1 having a positive refractive power and the second optical system U2 along the optical path in order from the enlargement side to the reduction side. The first optical system U1 consists of lenses L1 to L13 in order from the enlargement side to the reduction side. The second optical system U2 consists of a first lens group G1, a second lens group G2, a third lens group G3, and a fourth lens group G4 in order from the enlargement side to the reduction side.

During changing magnification, each of the first lens group G1, the second lens group G2, and the third lens group G3 moves along the optical axis Z while changing a spacing to an adjacent group. During changing magnification, each of the first optical system U1 and the fourth lens group G4 is fixed to the reduction-side imaging plane. In FIG. 1, a schematic movement locus of each of the lens groups during changing magnification from the wide angle end to the telephoto end is indicated by a solid-line arrow below each of the lens groups that move during changing magnification.

For example, each of the lens groups in FIG. 1 is configured as follows. The first lens group G1 consists of one lens L21. The second lens group G2 consists of two lenses L22 and L23 and an aperture stop St in order from the enlargement side to the reduction side. The third lens group G3 consists of six lenses L24 to L29 in order from the enlargement side to the reduction side. The fourth lens group G4 consists of one lens L30.

The zoom lens of FIG. 1 includes a focusing group Gf as a group that moves along the optical axis Z during focusing. For example, the focusing group Gf in the example of FIG. 1 consists of two lenses L4 and L5. In FIG. 1, the reference numeral Gf and both arrows in the horizontal direction of the lenses L4 and L5 represent that the lenses L4 and L5 are the focusing group Gf.

It is preferable that the second optical system U2 includes a stationary lens group that is fixed to the reduction-side imaging plane closest to the reduction side during changing magnification. For example, as in the example of FIG. 1, the second optical system U2 may be configured to consist of the first movable lens group, the second movable lens group, the third movable lens group, and the stationary lens group along the optical path in order from the enlargement side to the reduction side. By fixing the lens group closest to the reduction side during changing magnification, the telecentricity of the reduction side is easily ensured while maintaining a high zoom magnification.

It is preferable that the stationary lens group in the second optical system U2 has a positive refractive power. In this case, an increase in the diameter of the third movable lens group disposed closer to the enlargement side than the stationary lens group is easily suppressed.

The first optical system U1 may be configured to have a positive refractive power and to be fixed to the reduction-side imaging plane during changing magnification. In this case, this configuration is advantageous in reducing the size of the lens system and simplifying the magnification changing mechanism.

In the zoom lens according to the present disclosure, it is preferable that the reduction side is configured to be telecentric. In this case, in a case where a function of shifting the projection optical system in a direction perpendicular to the optical axis relative to an image display element to adjust a position of a projection image on the screen, that is, a so-called lens shift function is realized, this configuration is advantageous in ensuring the amount of shift. To be exact, in the optical system where the reduction side is configured to be telecentric, a principal ray moving from the surface of the optical system closest to the reduction side to the reduction-side imaging plane is parallel to the optical axis Z.

However, “the reduction side being telecentric” in the present disclosed technology is not limited to a case where the angle of the above-described principal ray with respect to the optical axis Z is 0 degree, and includes an error that is practically allowed in the technical field to which the present disclosed technology belongs. The error may be, for example, in a range where the angle of the above-described principal ray with respect to the optical axis Z is −3 degrees or more and +3 degrees or less. In a system that does not include an aperture stop, in a case where luminous fluxes are seen in a direction from the enlargement side to the reduction side, the telecentricity may be determined by using, as a substitute for the principal ray, an angle bisector between the maximum luminous flux on the upper side and the maximum luminous flux on the lower side in a cross section of a luminous flux focused on any point on the image display surface Sim that is the reduction-side imaging plane.

It is preferable that the second movable lens group has a negative refractive power. In this case, this configuration is advantageous in suppressing a variation in various aberrations during changing magnification.

It is preferable that the second movable lens group consists of one negative lens and one positive lens. In this case, this configuration is advantageous in suppressing occurrence of field curvature and chromatic aberration.

It is preferable that the first optical system U1 includes a cemented lens where a positive lens, a negative lens, and a positive lens are cemented in this order. In this case, this configuration is advantageous in correcting chromatic aberration.

It is preferable that an effective diameter of an enlargement-side surface of a second lens from the enlargement side in the first optical system U1 at the wide angle end is less than an effective diameter of an enlargement-side surface of a lens closest to the reduction side in the first optical system U1 at the wide angle end. In general, in a case where it is attempted to increase the angle of view in a zoom lens that forms an intermediate image, the diameter of the lens on the enlargement side is likely to increase. In the above-described configuration, an increase in the diameter of the lens on the enlargement side can be suppressed, which is advantageous in reducing the weight. By reducing the weight of the zoom lens, for example, in a case where the zoom lens is mounted on the projection type display device having the lens shift function, a load on the shift mechanism can be reduced.

In the present specification, it is assumed that, among rays that are incident on a lens surface from the enlargement side and are emitted to the reduction side, a length that is two times a distance from an intersection between the lens surface and a ray passing through the outermost side of the lens surface to the optical axis Z is the “effective diameter” of the lens surface. The “outer side” described herein is the radially outside with respect to the optical axis Z, that is, the side away from the optical axis Z.

In the zoom lens according to the present disclosure, it is preferable that the first movable lens group at the telephoto end is positioned closer to the enlargement side than the first movable lens group at the wide angle end. Likewise, it is preferable that the second movable lens group at the telephoto end is positioned closer to the enlargement side than the second movable lens group at the wide angle end. Likewise, it is preferable that the third movable lens group at the telephoto end is positioned closer to the enlargement side than the third movable lens group at the wide angle end. In this case, this configuration is advantageous in simplifying the drive mechanism.

In addition, in the zoom lens according to the present disclosure, it is preferable that, during changing magnification from the wide angle end to the telephoto end, each of the first movable lens group, the second movable lens group, and the third movable lens group constantly moves to the enlargement side. In this case, this configuration is more advantageous in simplifying the drive mechanism.

In the zoom lens according to the present disclosure, a first optical path bending member that bends the optical path may be configured to be disposed in the first optical system U1. By bending the optical path, a compact configuration can be adopted, which is advantageous in reducing the size. In a case where the zoom lens having a configuration where the optical path is bent once is mounted on the projection type display device, a portion closer to the reduction side than the bending portion is accommodated in a housing of the device main body, and a portion closer to the enlargement side than the bending portion is accommodated in a protruding portion that protrudes from the housing. In this case, by disposing the optical path bending member in the first optical system U1 on the enlargement side, the length from the lens closest to the enlargement side to the bending portion can be reduced, which is advantageous in reducing the size of the protruding portion. In addition, by rotating the bending portion, the lens closest to the enlargement side can be positioned in any direction, and thus an image can be projected in various directions. As the first optical path bending member, for example, a prism or a mirror having a reflecting surface can be used.

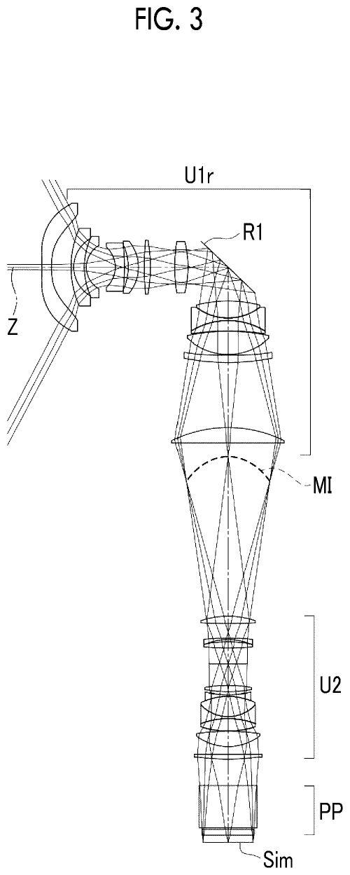

As a first modification example of the zoom lens of FIG. 1, FIG. 3 shows an example of the zoom lens including the first optical path bending member. The zoom lens of FIG. 3 consists of a first optical system U1r and the second optical system U2 along the optical path in order from the enlargement side to the reduction side. The zoom lens of FIG. 3 is different from the zoom lens of FIG. 1 in that a mirror R1 is disposed in the first optical system U1r and bents the optical path, and the other configurations of the lens are the same as those of the example of FIG. 1. The mirror R1 corresponds to the first optical path bending member according to the present disclosure. FIG. 3 shows the configuration at the wide angle end, and some of the reference numerals of the lenses are not shown to avoid the drawing from being complicated.

In the zoom lens according to the present disclosure, a second optical path bending member that bends the optical path may be configured to be disposed closer to the reduction side than the first optical system U1. By bending the optical path, a compact configuration can be adopted, which is advantageous in reducing the size. The total length of the optical system having the intermediate image MI tends to increase, but by bending the optical path at a position closer to the reduction side than the first optical system U1, an increase in the length of the optical system in one direction can be suppressed. In addition, by rotating the bending portion, the lens closest to the enlargement side can be positioned in any direction, and thus an image can be projected in various directions. As the second optical path bending member, for example, a prism or a mirror having a reflecting surface can be used.

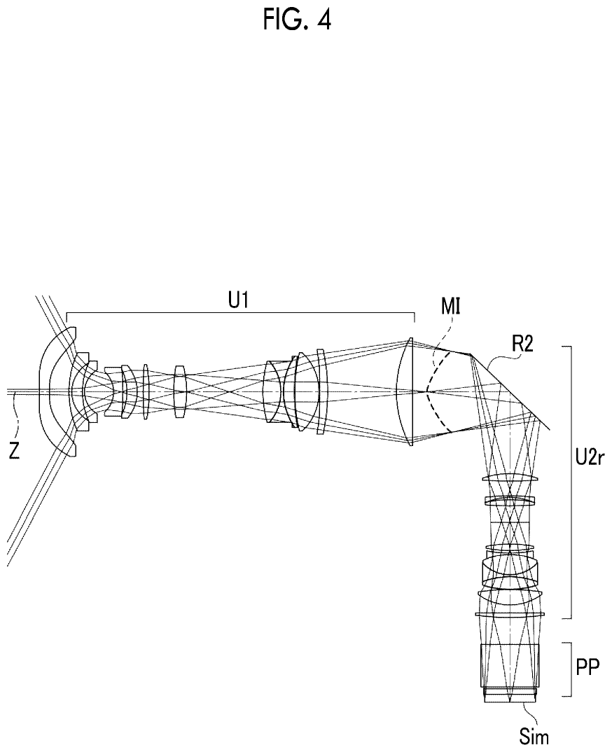

As a second modification example of the zoom lens of FIG. 1, FIG. 4 shows an example of the zoom lens including the second optical path bending member. The zoom lens of FIG. 4 consists of the first optical system U1 and a second optical system U2r along the optical path in order from the enlargement side to the reduction side. The zoom lens of FIG. 4 is different from the zoom lens of FIG. 1 in that a mirror R2 is disposed in the second optical system U2r closest to the enlargement side and bents the optical path, and the other configurations of the lens are the same as those of the example of FIG. 1. The mirror R2 corresponds to the second optical path bending member according to the present disclosure. FIG. 4 shows the configuration at the wide angle end, and some of the reference numerals of the lenses are not shown to avoid the drawing from being complicated.

In the zoom lens according to the present disclosure, the first optical path bending member that bends the optical path may be configured to be disposed in the first optical system U1, and the second optical path bending member that bends the optical path may be configured to be disposed closer to the reduction side than the first optical system U1. By bending the optical path twice, a compact configuration can be adopted, which is more advantageous in reducing the size. In a case where the zoom lens having a configuration where the optical path is bent twice is mounted on the projection type display device, by rotating each of the two bending portions, the lens closest to the enlargement side can be positioned in any direction, and thus an image can be projected in various directions.

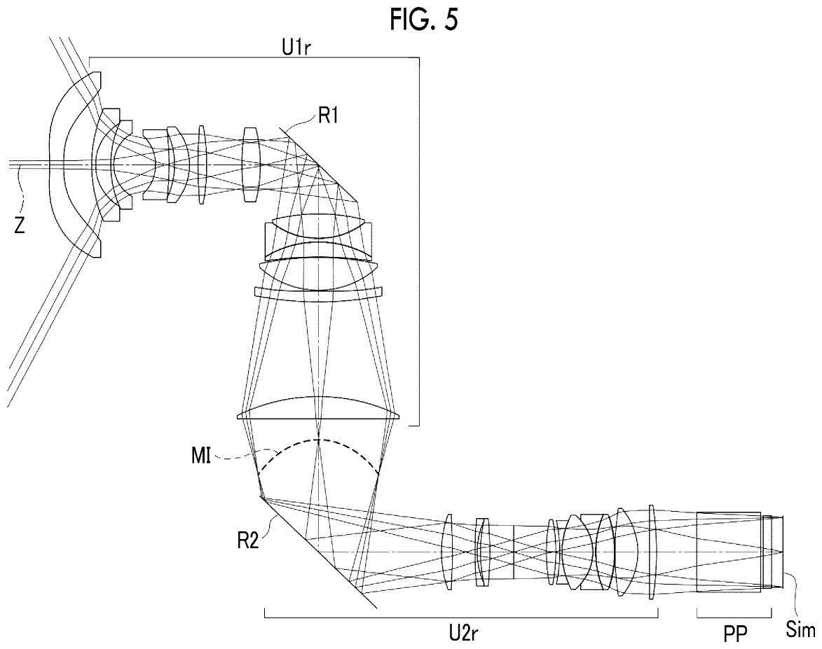

As a third modification example of the zoom lens of FIG. 1, FIG. 5 shows an example of the zoom lens that includes two optical path bending members and where the optical path is bent two times. The zoom lens of FIG. 5 consists of a first optical system U1r and a second optical system U2r along the optical path in order from the enlargement side to the reduction side. The first optical system U1r of FIG. 5 is the same as the first optical system U1r of FIG. 3, and the second optical system U2r of FIG. 5 is the same as the second optical system U2r in the example of FIG. 4. The mirror R1 corresponds to the first optical path bending member according to the present disclosure, and the mirror R2 corresponds to the second optical path bending member according to the present disclosure. FIG. 5 shows the configuration at the wide angle end, and some of the reference numerals of the lenses are not shown to avoid the drawing from being complicated.

An angle at which the optical path bending member bends the optical path can be freely set and may be, for example, 90 degrees. By setting the bending angle to 90 degrees, a structure that can be easily produced can be adopted. It should be noted that “the 90 degrees” includes an error that is practically allowed in the technical field to which the present disclosed technology belongs. The error may be, for example, +5 degrees.

Next, preferable configurations relating to conditional expressions of the zoom lens according to the present disclosure will be described. In the following description relating to the conditional expressions, in order to avoid redundant description, factors having the same definition will be represented by the same symbols, and the description thereof will not be repeated.

In a case where a focal length of the zoom lens at the wide angle end is represented by fw and a focal length of the first optical system U1 is represented by fr1, it is preferable that the zoom lens satisfies Conditional Expression (1). fw is a value in a state where the projection distance is 0.97 meters (m). The projection distance is a distance on the optical axis from the enlargement-side imaging plane to the lens surface closest to the enlargement side. By setting the corresponding value of Conditional Expression (1) not to be the lower limit value or less, the refractive power of the first optical system U1 is not excessively strong, which is advantageous in correcting various aberrations. By setting the corresponding value of Conditional Expression (1) not to be the upper limit value or more, the refractive power of the first optical system U1 is not excessively weak, which is advantageous in increasing the angle of view. In order to obtain more satisfactory characteristics, it is more preferable that the zoom lens satisfies Conditional Expression (1-1), and it is still more preferable that the zoom lens satisfies Conditional Expression (1-2).

$$0.8 < fr 1 / \vert fw \vert < 5 \qquad ( 1 )$$

$$1 < fr 1 / \vert fw \vert < 3 \qquad ( 1 ‐ 1 )$$

$$1.5 < fr 1 / \vert fw \vert < 2.5 \qquad ( 1 ‐ 2 )$$

In a case where a focal length of the first movable lens group is represented by f1 and a focal length of the second movable lens group is represented by f2, It is preferable that the zoom lens satisfies Conditional Expression (2). Regarding the lower limit of Conditional Expression (2), |f1/f2| is an absolute value, and thus 0<|f1/f2| is satisfied. By setting the corresponding value of Conditional Expression (2) not to be the upper limit value or more, the refractive power of the second movable lens group is not excessively strong, and a balance between the refractive powers of the first movable lens group and the second movable lens group can be satisfactorily maintained, which is advantageous in suppressing occurrence of various aberrations. In order to obtain more satisfactory characteristics, it is more preferable that the zoom lens satisfies Conditional Expression (2-1), and it is still more preferable that the zoom lens satisfies Conditional Expression (2-2).

$$0 \text{<\textbar} f 1 / f 2 \vert < 0.75 \qquad ( 2 )$$

$$0 \text{<\textbar} f 1 / f 2 \vert < 0.6 \qquad ( 2 ‐ 1 )$$

$$0 < \vert f 1 / f 2 \vert < 0.5 \qquad ( 2 ‐ 2 )$$

In a case where a focal length of the third movable lens group is represented by f3, it is preferable that the zoom lens satisfies Conditional Expression (3). Regarding the lower limit of Conditional Expression (3), |f3/f2| is an absolute value, and thus 0<|f3/f2| is satisfied. By setting the corresponding value of Conditional Expression (3) not to be the upper limit value or more, the refractive power of the second movable lens group is not excessively strong, and a balance between the refractive powers of the second movable lens group and the third movable lens group can be satisfactorily maintained, which is advantageous in suppressing occurrence of various aberrations. In order to obtain more satisfactory characteristics, it is more preferable that the zoom lens satisfies Conditional Expression (3-1), and it is still more preferable that the zoom lens satisfies Conditional Expression (3-2).

$$0 < \vert f 3 / f 2 \vert < 0 \text{.75} \qquad ( 3 )$$

$$0 \text{<\textbar} f 3 / f 2 \vert < 0.6 \qquad ( 3 ‐ 1 )$$

$$0 < \vert f 3 / f 2 \vert < 0.5 \qquad ( 3 ‐ 2 )$$

It is preferable that the zoom lens satisfies Conditional Expression (4). By setting the corresponding value of Conditional Expression (4) not to be the lower limit value or less, the refractive power of the first movable lens group is not excessively strong, which is advantageous in suppressing occurrence of various aberrations during changing magnification. By setting the corresponding value of Conditional Expression (4) not to be the upper limit value or more, the refractive power of the third movable lens group is not excessively strong, which is advantageous in suppressing occurrence of various aberrations during changing magnification. In order to obtain more satisfactory characteristics, it is more preferable that the zoom lens satisfies Conditional Expression (4-1), and it is still more preferable that the zoom lens satisfies Conditional Expression (4-2).

$$0.5 < f 1 / f 3 < 2 \qquad ( 4 )$$

$$0.6 < f 1 / f 3 < 1.67 \qquad ( 4 ‐ 1 )$$

$$0.7 < f 1 / f 3 < 1.43 \qquad ( 4 ‐ 2 )$$

The above-described preferable configurations and available configurations including the configurations relating to the conditional expressions can be freely combined, and it is preferable to appropriately selectively adopt the combination according to required specifications.

Next, examples and modification examples of the zoom lens according to the present disclosure will be described, with reference to the drawings. It should be noted that the reference numerals attached in the cross-sectional views of the examples and the modification examples are used independently for the examples and the modification examples in order to avoid the description and the drawings from being complicated by an increase in the number of digits of the reference numerals. Therefore, even in a case where common reference numerals are attached in the drawings of different examples and modification examples, components do not necessarily have a common configuration.

### Example 1

FIGS. 1 and 2 are cross-sectional views showing a configuration and luminous fluxes of a zoom lens according to Example 1, and Illustration methods and configurations thereof are the same as described above. Thus, some of repeated description will not be given.

The zoom lens according to Example 1 consists of the first optical system U1 having a positive refractive power and the second optical system U2 in order from the enlargement side to the reduction side. The first optical system U1 consists of the lenses L1 to L13 in order from the enlargement side to the reduction side. The second optical system U2 consists of the first lens group G1, the second lens group G2, the third lens group G3, and the fourth lens group G4 in order from the enlargement side to the reduction side. The first lens group G1 consists of the lens L21. The second lens group G2 consists of the lenses L22 and L23 and the aperture stop St in order from the enlargement side to the reduction side. The third lens group G3 consists of the lenses L24 to L29 in order from the enlargement side to the reduction side. The fourth lens group G4 consists of the lens L30.

During changing magnification, each of the first lens group G1, the second lens group G2, and the third lens group G3 moves along the optical axis Z while changing a spacing to an adjacent group. During changing magnification, each of the first optical system U1 and the fourth lens group G4 is fixed to the reduction-side imaging plane. The focusing group Gf consists of the lenses L4 and L5.

Regarding the zoom lens according to Example 1, Tables 1A and 1B show basic lens data, Table 2 shows specifications and variable surface spacings, and Table 3 shows aspherical coefficients. Here, the basic lens data is shown to be divided into two tables including Tables 1A and 1B, in order to avoid an increase in the length of one table. Table 1A shows the first optical system U1, and Table 1B shows the second optical system U2 and the optical member PP.

The table of the basic lens data is described as follows. The “Sn” column shows surface numbers in a case where the surface closest to the enlargement side is the first surface and the number is increased one by one toward the reduction side. The “R” column shows a curvature radius of each surface. The “D” column shows a surface spacing between each surface and the surface adjacent to the reduction side on the optical axis. The “Nd” column shows a refractive index of each component with respect to the d line. The “vd” column shows an Abbe number of each component with respect to the d line. The “ED” column shows an effective diameter in terms of diameter. ED shows only the values of only the enlargement-side surface of the second lens from the enlargement side in the first optical system U1 and the enlargement-side surface of the lens closest to the reduction side in the first optical system U1, and the column of Table 1B does not show any value.

In the table of the basic lens data, the sign of the curvature radius of a surface that is convex to the enlargement side is positive, and the sign of the curvature radius of a surface that is convex to the reduction side is negative. In the fields of the surface number of the surface corresponding to the aperture stop St, the surface number and the expression (St) are shown. The value in the bottom field of the column D in Table 1B indicates a spacing between the image display surface Sim and the surface closest to the reduction side in the table. In the table of basic lens data, the symbol DD [ ] is used for the variable surface spacing during changing magnification, and the surface number of the enlargement-side surface of the spacing is given in [ ] and is shown in the column D.

Table 2 shows the zoom magnification Zr, the absolute value of the focal length |f|, the F number F No., the maximum total angle of view 20, and the variable surface spacing, with respect to the d line. [°] in the fields of 20 indicates that the unit thereof is a degree. The values in Tables 1 and 2 the values in a state where the projection distance is 0.97 meters (m). In Table 2, the “Wide Angle End” column shows each of the values at the wide angle end, the “Middle” column shows each of the values in the middle focal length state, and the “Telephoto End” column shows each of the values at the telephoto end.

In the basic lens data, a reference sign * is attached to surface numbers of aspherical surfaces, and values of paraxial curvature radius are shown in the fields of the curvature radius of the aspherical surface. In Table 3, the Sn row shows the surface number of the aspherical surface, and the KA and Am rows (where m=3, 4, 5, . . . , and 20) show numerical values of the aspherical coefficients for the aspherical surfaces. The “E±n” (n: an integer) in the numerical values of the aspherical coefficients of Table 3 indicates “x10^{±n}”. KA and Am are the aspherical coefficients in an aspheric equation represented by the following expression.

$$Z d = C \times {h}^{2} / \{ 1 + {( 1 ‐ KA \times {C}^{2} \times {h}^{2} )}^{1 / 2} \} + \sum Am \times {h}^{m}$$

where
Zd: an aspherical surface depth (a length of a perpendicular from a point on an aspherical surface at a height h to a plane that is perpendicular to the optical axis Z and in contact with the aspherical surface apex),
h: a height (a distance from the optical axis Z to the lens surface),
C: a reciprocal of the paraxial curvature radius, and
KA, Am: aspherical coefficients.
Σ in the aspheric equation represents the total sum regarding m.

In the data of each of the tables, degrees are used as the unit of an angle, and millimeters (mm) are used as the unit of a length. However, appropriate different units may be used because the optical system can be used even in a case where the system is enlarged or reduced in proportion. Further, each of the following tables shows numerical values rounded off to predetermined decimal places.

TABLE 1A
Example 1

| Sn | R | D | Nd | νd | ED |
|---|---|---|---|---|---|
| *1 | −106.8168 | 5.0200 | 1.53638 | 56.09 | |
| *2 | 67.2451 | 10.1900 | | | |
| 3 | 54.0823 | 1.4200 | 1.83481 | 42.72 | 49.73 |
| 4 | 18.5861 | 5.5230 | | | |
| 5 | 40.4187 | 1.0500 | 1.86966 | 20.02 | |
| 6 | 14.1571 | 15.1000 | | | |
| 7 | −15.4041 | 4.8500 | 1.48749 | 70.44 | |
| 8 | −124.2882 | 2.0155 | | | |
| 9 | −29.9406 | 5.3100 | 1.80420 | 46.50 | |
| 10 | −23.0974 | 3.0700 | | | |
| 11 | 181.9978 | 3.1400 | 1.80809 | 22.76 | |
| 12 | −85.1490 | 12.6900 | | | |
| 13 | 90.1357 | 6.6300 | 1.59282 | 68.62 | |
| 14 | −60.4140 | 39.5000 | | | |
| 15 | 63.7297 | 9.2600 | 1.49700 | 81.61 | |
| 16 | −26.3132 | 1.3800 | 1.92286 | 20.88 | |
| 17 | 35.4623 | 5.6300 | 1.60311 | 60.64 | |
| 18 | 121.4384 | 0.2000 | | | |
| 19 | 97.1293 | 12.3500 | 1.49700 | 81.61 | |
| 20 | −30.4975 | 0.3000 | | | |
| *21 | −666.6656 | 4.1000 | 1.51633 | 64.06 | |
| *22 | −98.8447 | 35.5400 | | | |
| 23 | 63.5148 | 8.3800 | 1.84661 | 23.88 | 56.62 |
| 24 | ∞ | DD[24] | | | |

TABLE 1B
Example 1

| Sn | R | D | Nd | νd |
|---|---|---|---|---|
| 25 | 42.2252 | 3.9400 | 1.65160 | 58.54 |
| 26 | −284.6768 | DD[26] | | |
| 27 | 126.4576 | 0.8000 | 1.94595 | 17.98 |
| 28 | 29.6768 | 1.2229 | | |
| 29 | 58.0168 | 3.3400 | 1.83481 | 42.72 |
| 30 | −147.6677 | 8.7300 | | |
| 31(St) | ∞ | DD[31] | | |
| 32 | 65.5246 | 3.4300 | 1.92286 | 20.88 |
| 33 | −65.5246 | 1.4400 | | |
| 34 | −58.5357 | 0.8500 | 1.83481 | 42.72 |
| 35 | 31.5548 | 0.0247 | | |
| 36 | 31.8622 | 10.9800 | 1.48749 | 70.44 |
| 37 | −19.0114 | 0.0420 | | |
| 38 | −18.8679 | 1.0200 | 1.83481 | 42.72 |
| 39 | 37.9471 | 6.7400 | 1.49700 | 81.61 |
| 40 | −45.9868 | 0.2000 | | |
| 41 | 105.9732 | 8.3200 | 1.51680 | 64.20 |
| 42 | −26.6617 | DD[42] | | |
| 43 | ∞ | 2.5700 | 1.94595 | 17.98 |
| 44 | −120.7806 | 14.5000 | | |
| 45 | ∞ | 23.0000 | 1.51680 | 64.20 |
| 46 | ∞ | 1.0000 | | |
| 47 | ∞ | 3.0000 | 1.48749 | 70.44 |
| 48 | ∞ | 4.1255 | | |

TABLE 2
Example 1

| | Wide Angle End | Middle | Telephoto End |
|---|---|---|---|
| Zr | 1.00 | 1.15 | 1.33 |
| \|f\| | 6.68 | 7.68 | 8.88 |
| F No. | 2.19 | 2.28 | 2.41 |
| 2ω[°] | 126.4 | 119.6 | 112.2 |
| DD[24] | 94.6045 | 84.9517 | 75.2795 |
| DD[26] | 8.1100 | 10.5404 | 12.1608 |
| DD[31] | 11.6600 | 12.7878 | 12.2818 |
| DD[42] | 4.2400 | 10.3345 | 18.8925 |

TABLE 3
Example 1

| Sn | 1 | 2 | 21 | 22 |
|---|---|---|---|---|
| KA | 2.4954715E+00 | −2.4999450E+00 | 1.0000000E+00 | 1.0000000E+00 |
| A3 | −4.7558748E−04 | −1.8888411E−04 | 0.0000000E+00 | 0.0000000E+00 |
| A4 | 1.7148940E−04 | 8.1800326E−05 | 8.7328534E−06 | 9.7216509E−06 |
| A5 | −1.0797125E−05 | 3.9323057E−06 | −1.9108283E−06 | 1.0219914E−06 |
| A6 | 4.5042978E−08 | −1.0434428E−06 | 2.8743336E−07 | −3.2936771E−07 |
| A7 | 3.5211036E−08 | 3.5036012E−08 | −3.3795273E−08 | 1.1822850E−08 |
| A8 | −1.8128331E−09 | 3.7325394E−09 | 1.1881814E−09 | 3.7919069E−09 |
| A9 | −2.5553700E−11 | −2.9092999E−10 | 2.6173408E−10 | −3.5471843E−10 |
| A10 | 5.1026685E−12 | −4.3642188E−12 | −3.5447612E−11 | −1.4659173E−11 |
| A11 | −9.1397670E−14 | 9.5564303E−13 | 3.6567770E−13 | 2.5872694E−12 |
| A12 | −5.7869831E−15 | −9.3315372E−15 | 1.8023617E−13 | −1.7607274E−15 |
| A13 | 2.1879639E−16 | −1.6522588E−15 | −7.9299634E−15 | −8.6874400E−15 |
| A14 | 2.3283682E−18 | 3.6382858E−17 | −3.4657738E−16 | 1.4763919E−16 |
| A15 | −1.9699700E−19 | 1.5851165E−18 | 2.6442882E−17 | 1.5139506E−17 |
| A16 | 6.7286714E−22 | −4.7931798E−20 | 1.2928030E−19 | −3.8742790E−19 |
| A17 | 8.2652855E−23 | −7.9637833E−22 | −3.6373516E−20 | −1.3343527E−20 |
| A18 | −8.2532057E−25 | 2.9545294E−23 | 3.6195614E−22 | 4.1324747E−22 |
| A19 | −1.3476262E−26 | 1.6290989E−25 | 1.8483825E−23 | 4.7170243E−24 |
| A20 | 1.8462690E−28 | −7.1591810E−27 | −3.2891336E−25 | −1.6418867E−25 |

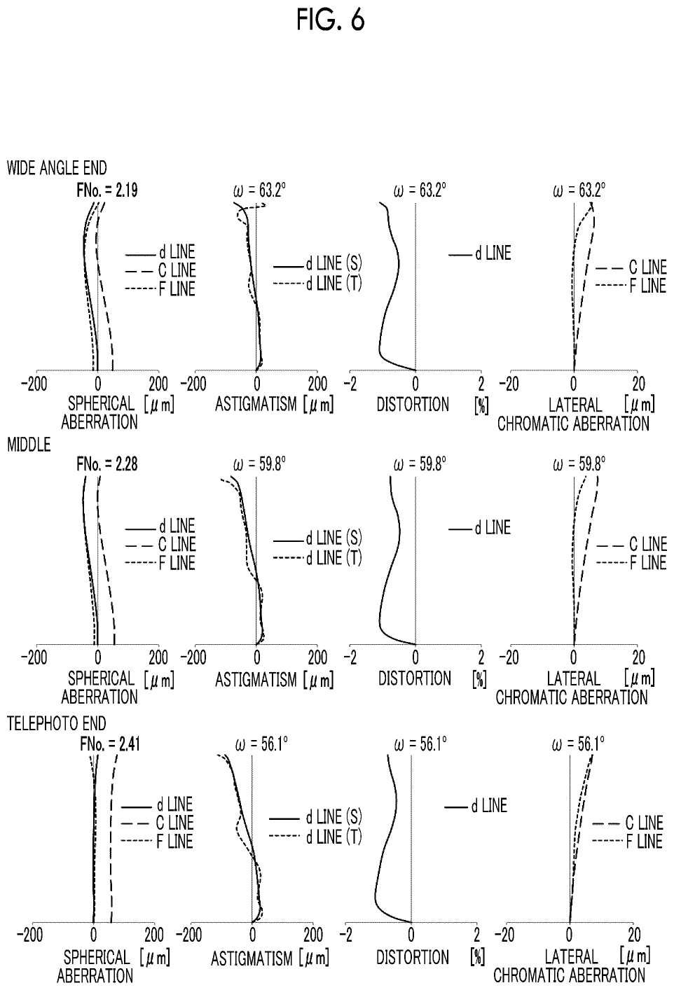

FIG. 6 shows each of aberration diagrams in the zoom lens of Example 1 in a state where the projection distance is 0.97 meters (m). FIG. 6 shows, in order from the left, a spherical aberration, astigmatism, distortion, and lateral chromatic aberration. In FIG. 6, the upper stage to which “wide angle end” is attached shows each of aberration diagrams at the wide angle end, the middle stage to which “middle” is attached shows each of aberration diagrams in the middle focal length state, and the lower stage to which “telephoto end” is attached shows each of aberration diagrams at the telephoto end. In the spherical aberration diagram, aberrations regarding the d line, the C line, and the F line are indicated by a solid line, a long broken line, and a short broken line, respectively. In the astigmatism diagram, an aberration regarding the d line in the sagittal direction is indicated by a solid line, and an aberration regarding the d line in the tangential direction is indicated by a short broken line. In the distortion diagram, an aberration regarding the d line is indicated by a solid line. In the lateral chromatic aberration diagram, aberrations regarding the C line and the F line are indicated by a long broken line and a short broken line, respectively. In the spherical aberration diagram, a value of the F number is shown after “F No.=”. In other aberration diagrams, the value of the maximum half angle of view is shown after “@=”.

FIGS. 3, 4, and 5 show cross-sectional views showing the configurations of the first modification example, the second modification example, and the third modification example of the zoom lens of according to Example 1, respectively. Since the configurations of the examples of FIGS. 3 to 5 are as described above, the repeated description thereof will not be given here.

Symbols, meanings, description methods, and illustration methods of the respective data pieces according to Example 1 and the modification example are basically similar to those in the following examples unless otherwise specified. Therefore, hereinafter, repeated description will not be given.

### Example 2

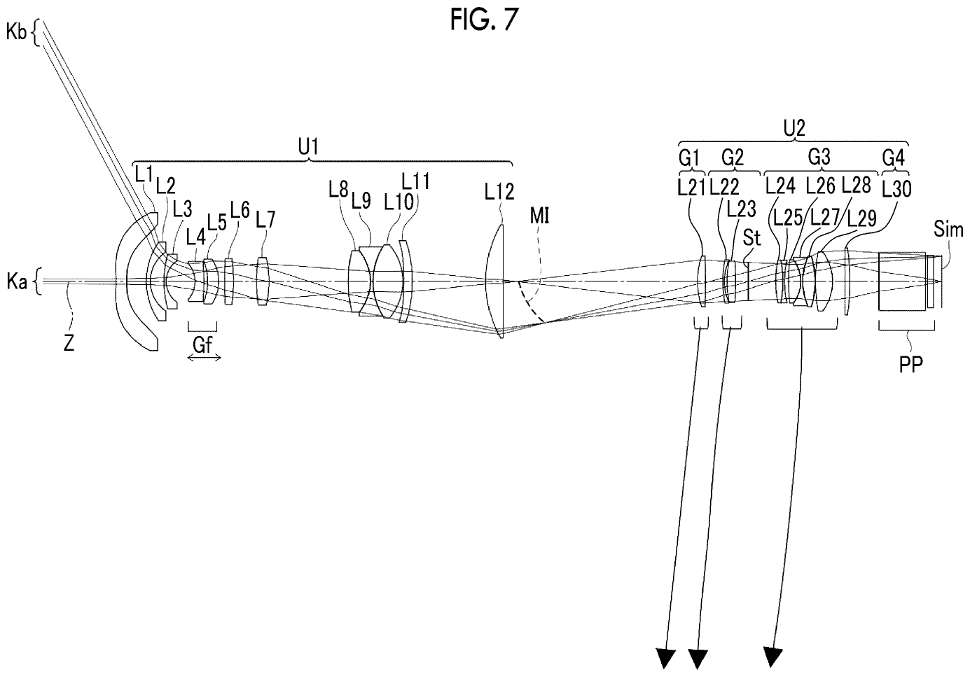

FIG. 7 is a cross-sectional view showing a configuration and luminous fluxes of a zoom lens according to Example 2 at the wide angle end. The zoom lens according to Example 2 consists of the first optical system U1 having a positive refractive power and the second optical system U2 in order from the enlargement side to the reduction side. The first optical system U1 consists of the lenses L1 to L12 in order from the enlargement side to the reduction side. The second optical system U2 consists of the first lens group G1, the second lens group G2, the third lens group G3, and the fourth lens group G4 in order from the enlargement side to the reduction side. The first lens group G1 consists of the lens L21. The second lens group G2 consists of the lenses L22 and L23 and the aperture stop St in order from the enlargement side to the reduction side. The third lens group G3 consists of the lenses L24 to L29 in order from the enlargement side to the reduction side. The fourth lens group G4 consists of the lens L30.

During changing magnification, each of the first lens group G1, the second lens group G2, and the third lens group G3 moves along the optical axis Z while changing a spacing to an adjacent group. During changing magnification, each of the first optical system U1 and the fourth lens group G4 is fixed to the reduction-side imaging plane. The focusing group Gf consists of the lenses L4 and L5.

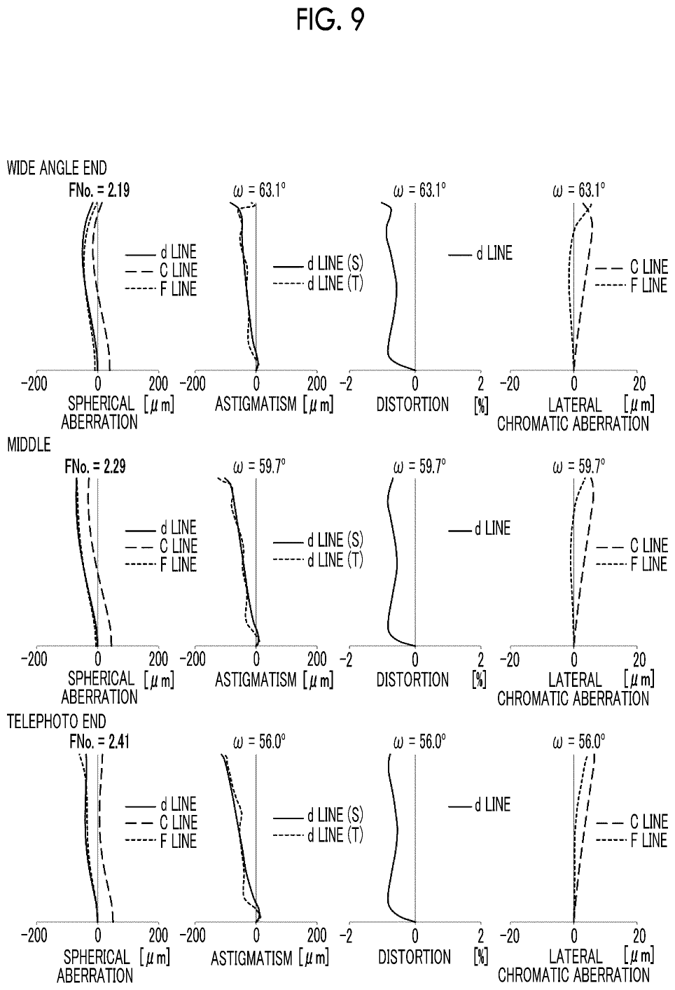

Regarding the zoom lens according to Example 2, Tables 4A and 4B show basic lens data, Table 5 shows specifications and variable surface spacings, Table 6 shows aspherical coefficients, and FIG. 9 shows each of aberration diagrams. The basic lens data, the specifications, and each of the aberration diagrams are those in a state where the projection distance is 0.97 meters (m).

TABLE 4A
Example 2

| Sn | R | D | Nd | νd | ED |
|---|---|---|---|---|---|
| *1 | −102.4443 | 5.1838 | 1.53638 | 56.09 | |
| *2 | 83.0560 | 9.7253 | | | |
| 3 | 37.5145 | 1.9996 | 1.83481 | 42.72 | 41.32 |
| 4 | 19.3773 | 6.8865 | | | |
| 5 | 59.2624 | 1.0503 | 1.86966 | 20.02 | |
| 6 | 13.6979 | 14.2718 | | | |
| 7 | −14.9099 | 4.3971 | 1.48749 | 70.44 | |
| 8 | −142.7042 | 1.9343 | | | |
| 9 | −28.5648 | 5.6051 | 1.77250 | 49.62 | |
| 10 | −21.8287 | 2.9292 | | | |
| 11 | 217.4138 | 4.3606 | 1.86966 | 20.02 | |
| 12 | −95.8652 | 11.4358 | | | |
| 13 | 90.2819 | 6.2174 | 1.59282 | 68.62 | |
| 14 | −57.2604 | 39.5000 | | | |
| 15 | 78.1200 | 10.8425 | 1.48749 | 70.44 | |
| 16 | −26.3158 | 1.3801 | 1.86966 | 20.02 | |
| 17 | 35.3884 | 14.9031 | 1.55032 | 75.50 | |
| 18 | −31.1160 | 0.4662 | | | |
| *19 | −240.3695 | 4.0993 | 1.58913 | 61.15 | |
| *20 | −86.1137 | 36.4776 | | | |
| 21 | 63.3059 | 8.5243 | 1.84661 | 23.88 | 56.88 |
| 22 | ∞ | DD[22] | | | |

TABLE 4B
Example 2

| Sn | R | D | Nd | νd |
|---|---|---|---|---|
| 23 | 43.2250 | 3.9702 | 1.65160 | 58.54 |
| 24 | −290.7590 | DD[24] | | |
| 25 | 62.5723 | 0.8000 | 1.94595 | 17.98 |
| 26 | 26.8699 | 1.3245 | | |
| 27 | 53.7281 | 4.3081 | 1.69680 | 55.53 |
| 28 | −133.5394 | 6.4331 | | |
| 29(St) | ∞ | DD[29] | | |
| 30 | 61.8466 | 3.5066 | 1.94595 | 17.98 |
| 31 | −65.0745 | 0.0308 | | |
| 32 | −63.3312 | 0.8500 | 2.00100 | 29.13 |
| 33 | 52.7241 | 1.9999 | | |
| 34 | 126.9242 | 6.1289 | 1.48749 | 70.44 |
| 35 | −18.9229 | 1.0200 | 1.80420 | 46.50 |
| 36 | 34.9829 | 6.0744 | 1.49700 | 81.61 |
| 37 | −48.6871 | 0.2000 | | |
| 38 | 87.9651 | 8.4259 | 1.51680 | 64.20 |
| 39 | −26.9971 | DD[39] | | |
| 40 | ∞ | 2.5007 | 1.94595 | 17.98 |
| 41 | −121.9908 | 14.5000 | | |
| 42 | ∞ | 23.0000 | 1.51680 | 64.20 |
| 43 | ∞ | 1.0000 | | |
| 44 | ∞ | 3.0000 | 1.48749 | 70.44 |
| 45 | ∞ | 4.0895 | | |

TABLE 5
Example 2

| | Wide Angle End | Middle | Telephoto End |
|---|---|---|---|
| Zr | 1.00 | 1.15 | 1.33 |
| \|f\| | 6.70 | 7.70 | 8.91 |
| F No. | 2.19 | 2.29 | 2.41 |
| 2ω[°] | 126.2 | 119.4 | 112.0 |
| DD[22] | 96.8902 | 87.4592 | 77.6902 |
| DD[24] | 8.4929 | 11.3022 | 13.2080 |
| DD[29] | 13.5545 | 14.4309 | 13.8989 |
| DD[39] | 6.2148 | 11.9581 | 20.3557 |

TABLE 6
Example 2

| Sn | 1 | 2 | 19 | 20 |
|---|---|---|---|---|
| KA | 2.4999950E+00 | −1.5486737E+00 | 1.0000000E+00 | 1.0000000E+00 |
| A3 | −4.8629957E−04 | −3.1584518E−04 | 0.0000000E+00 | 0.0000000E+00 |
| A4 | 1.6282277E−04 | 1.0502595E−04 | −1.1736800E−06 | −6.1958851E−06 |
| A5 | −7.2229312E−06 | 4.2923205E−06 | −7.7298344E−07 | 3.3593082E−06 |
| A6 | −2.5489547E−07 | −1.1241371E−06 | 2.2808442E−07 | −5.4693176E−07 |
| A7 | 2.8345976E−08 | 1.9440268E−08 | −5.4403562E−08 | 1.4716824E−08 |
| A8 | −2.6166951E−11 | 4.1362214E−09 | 4.0330037E−09 | 3.7838844E−09 |
| A9 | −6.0683702E−11 | −1.5179442E−10 | 2.3223162E−10 | −2.9462920E−10 |
| A10 | 1.1883698E−12 | −7.5431939E−12 | −4.6134878E−11 | −8.6017360E−12 |
| A11 | 6.8602601E−14 | 3.8722107E−13 | 8.1661106E−13 | 1.4695508E−12 |
| A12 | −2.2736308E−15 | 6.9280777E−15 | 1.7239927E−13 | −6.3229517E−15 |
| A13 | −4.3661080E−17 | −4.9882069E−16 | −7.5681180E−15 | −3.5356988E−15 |
| A14 | 2.1450802E−18 | −2.5998874E−18 | −2.6874743E−16 | 6.2801792E−17 |
| A15 | 1.6536019E−20 | 3.4939733E−19 | 1.9723460E−17 | 4.5370905E−18 |
| A16 | −1.2041188E−21 | −4.0641175E−22 | 8.8935240E−20 | −1.1317153E−19 |
| A17 | −3.6760356E−24 | −1.2684592E−22 | −2.2614451E−20 | −2.9940556E−21 |
| A18 | 3.9673877E−25 | 6.0617118E−25 | 1.9057002E−22 | 8.7733680E−23 |
| A19 | 3.5966742E−28 | 1.8702511E−26 | 9.8192075E−24 | 8.0113560E−25 |
| A20 | −5.9179795E−29 | −1.3129697E−28 | −1.5091598E−25 | −2.5720537E−26 |

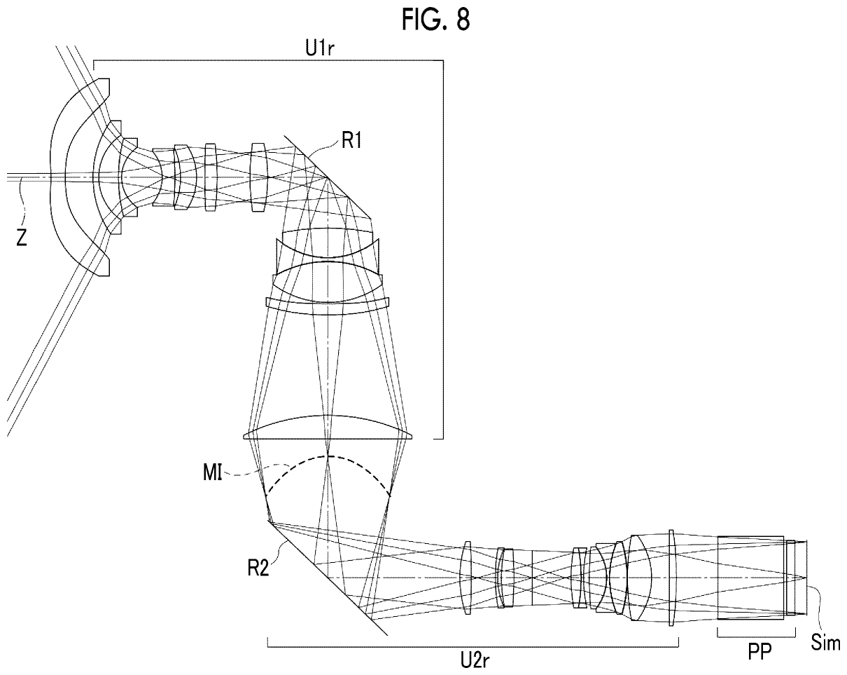

FIG. 8 shows a configuration and luminous fluxes of a modification example of the zoom lens according to Example 2 at the wide angle end. The zoom lens of FIG. 8 includes two optical path banding numbers, and thus the optical path is bent twice. The zoom lens of FIG. 8 consists of a first optical system U1r and a second optical system U2r along the optical path in order from the enlargement side to the reduction side. The first optical system U1r of FIG. 8 is different from the first optical system U1 according to Example 2 in that a mirror R1 is disposed in the first optical system U1r and bents the optical path. The second optical system U2r of FIG. 8 is different from the second optical system U2 according to Example 2 in that a mirror R2 is disposed in the second optical system U2r closest to the enlargement side and bents the optical path. The other configurations of the zoom lens of FIG. 8 are the same as those of the zoom lens according to Example 2.

### Example 3

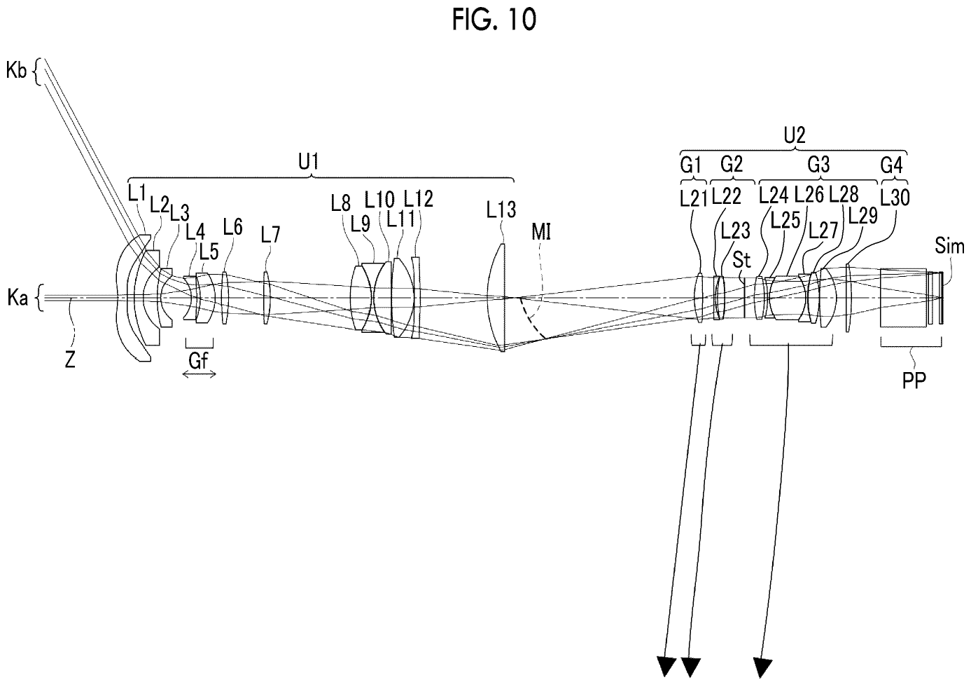

FIG. 10 is a cross-sectional view showing a configuration and luminous fluxes of a zoom lens according to Example 3 at the wide angle end. The zoom lens according to Example 3 consists of the first optical system U1 having a positive refractive power and the second optical system U2 in order from the enlargement side to the reduction side. The first optical system U1 consists of the lenses L1 to L13 in order from the enlargement side to the reduction side. The second optical system U2 consists of the first lens group G1, the second lens group G2, the third lens group G3, and the fourth lens group G4 in order from the enlargement side to the reduction side. The first lens group G1 consists of the lens L21. The second lens group G2 consists of the lenses L22 and L23 and the aperture stop St in order from the enlargement side to the reduction side. The third lens group G3 consists of the lenses L24 to L29 in order from the enlargement side to the reduction side. The fourth lens group G4 consists of the lens L30.

During changing magnification, each of the first lens group G1, the second lens group G2, and the third lens group G3 moves along the optical axis Z while changing a spacing to an adjacent group. During changing magnification, each of the first optical system U1 and the fourth lens group G4 is fixed to the reduction-side imaging plane. The focusing group Gf consists of the lenses L4 and L5.

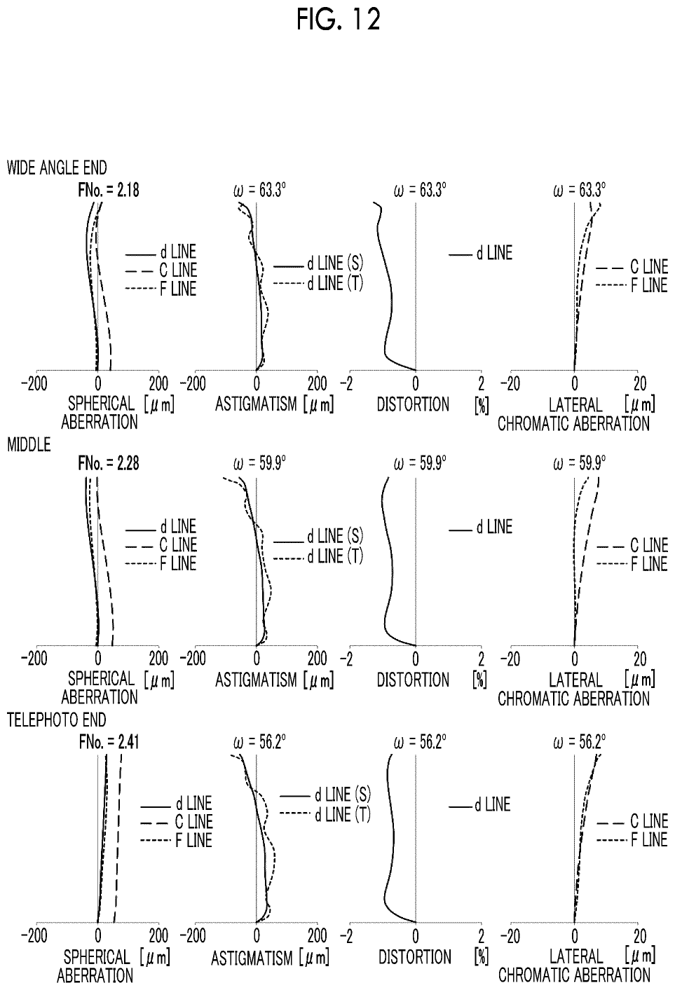

Regarding the zoom lens according to Example 3, Tables 7A and 7B show basic lens data, Table 8 shows specifications and variable surface spacings, Table 9 shows aspherical coefficients, and FIG. 12 shows each of aberration diagrams. The basic lens data, the specifications, and each of the aberration diagrams are those in a state where the projection distance is 0.97 meters (m).

TABLE 7A
Example 3

| Sn | R | D | Nd | νd | ED |
|---|---|---|---|---|---|
| *1 | −30.0477 | 4.6997 | 1.53638 | 56.09 | |
| *2 | −78.4526 | 3.4481 | | | |
| 3 | 55.3437 | 4.4930 | 1.83481 | 42.72 | 50.03 |
| 4 | 20.3962 | 6.9550 | | | |
| 5 | 58.5090 | 1.8088 | 1.86966 | 20.02 | |
| 6 | 14.5154 | 15.3183 | | | |
| 7 | −15.5243 | 2.6323 | 1.49700 | 81.61 | |
| 8 | −123.8964 | 1.7713 | | | |
| 9 | −33.1837 | 7.4421 | 1.80420 | 46.50 | |
| 10 | −24.1638 | 3.1819 | | | |
| 11 | 148.4440 | 3.5433 | 1.80518 | 25.46 | |
| 12 | −72.6066 | 17.2707 | | | |
| 13 | 433.2747 | 3.3369 | 1.59282 | 68.62 | |
| 14 | −54.1797 | 40.0000 | | | |
| 15 | 52.6666 | 10.4771 | 1.49700 | 81.61 | |
| 16 | −32.9366 | 1.2500 | 1.92286 | 20.88 | |
| 17 | 32.2862 | 8.7461 | 1.60311 | 60.64 | |
| 18 | ∞ | 0.2008 | | | |
| 19 | 154.9251 | 11.0873 | 1.49700 | 81.61 | |
| 20 | −32.3856 | 0.2000 | | | |
| *21 | −523.7012 | 3.0000 | 1.51633 | 64.06 | |
| *22 | −170.6891 | 33.5926 | | | |
| 23 | 61.6522 | 8.5021 | 1.84666 | 23.78 | 56.54 |
| 24 | ∞ | DD[24] | | | |

TABLE 7B
Example 3

| Sn | R | D | Nd | vd |
|---|---|---|---|---|
| 25 | 39.0595 | 4.1225 | 1.65160 | 58.54 |
| 26 | −290.8319 | DD[26] | | |
| 27 | ∞ | 0.8000 | 1.94595 | 17.98 |
| 28 | 32.1112 | 1.0571 | | |
| 29 | 58.4784 | 3.3899 | 1.83481 | 42.72 |
| 30 | −99.0675 | 9.8061 | | |
| 31(St) | ∞ | DD[31] | | |
| 32 | 52.2549 | 5.0166 | 1.92286 | 20.88 |
| 33 | −52.2549 | 1.6542 | | |
| 34 | −42.6652 | 0.9000 | 1.83481 | 42.72 |
| 35 | 20.9000 | 0.0819 | | |
| 36 | 21.3669 | 17.9999 | 1.49700 | 81.61 |
| 37 | −20.5137 | 0.0846 | | |
| 38 | −20.1701 | 1.0000 | 1.83481 | 42.72 |
| 39 | 49.4688 | 5.7158 | 1.49700 | 81.61 |
| 40 | −49.4688 | 0.2000 | | |
| 41 | 155.0372 | 8.4256 | 1.51680 | 64.20 |
| 42 | −25.2924 | DD[42] | | |
| 43 | ∞ | 2.6290 | 1.94595 | 17.98 |
| 44 | −111.1907 | 14.5000 | | |
| 45 | ∞ | 23.0000 | 1.51680 | 64.20 |
| 46 | ∞ | 1.0000 | | |
| 47 | ∞ | 2.0000 | 1.52300 | 58.76 |
| 48 | ∞ | 3.5800 | | |
| 49 | ∞ | 1.1000 | 1.50997 | 61.61 |
| 50 | ∞ | 0.4959 | | |

TABLE 8
Example 3

| | Wide Angle End | Middle | Telephoto End |
|---|---|---|---|
| Zr | 1.00 | 1.15 | 1.33 |
| \|f\| | 6.66 | 7.66 | 8.85 |
| F No. | 2.18 | 2.28 | 2.41 |
| 2ω[°] | 126.6 | 119.8 | 112.4 |
| DD[24] | 94.8687 | 85.5168 | 76.2936 |
| DD[26] | 5.6435 | 7.4428 | 8.6252 |
| DD[31] | 4.8859 | 6.3726 | 6.1135 |
| DD[42] | 4.8431 | 10.9060 | 19.2097 |

TABLE 9
Example 3

| Sn | 1 | 2 | 21 | 22 |
|---|---|---|---|---|
| KA | −6.3100148E−02 | 1.7647061E+00 | 1.0000000E+00 | 1.0000000E+00 |
| A3 | −4.1262880E−05 | 3.6116503E−04 | 0.0000000E+00 | 0.0000000E+00 |
| A4 | 2.3323245E−04 | 1.0960858E−04 | −1.0037781E−05 | −1.2126314E−05 |
| A5 | −1.5824531E−05 | 9.9953060E−07 | 3.0124928E−08 | 4.6141873E−06 |
| A6 | −6.8011684E−08 | −8.3545147E−07 | 8.3784037E−07 | 4.0499758E−08 |
| A7 | 5.6682868E−08 | 1.0953691E−08 | −1.2702191E−07 | −8.6251997E−08 |
| A8 | −2.0464789E−09 | 2.8646074E−09 | −1.3689307E−09 | 4.2372119E−09 |
| A9 | −6.9995137E−11 | −3.1548151E−11 | 1.3860786E−09 | 5.7028167E−10 |
| A10 | 6.5680278E−12 | −7.9274538E−12 | −5.4064496E−11 | −4.5445117E−11 |
| A11 | −5.6047448E−14 | 5.4376158E−14 | −5.8313551E−12 | −1.7225663E−12 |
| A12 | −8.3254126E−15 | 1.5577479E−14 | 3.9549424E−13 | 2.0167460E−13 |
| A13 | 2.3275548E−16 | −5.4541745E−17 | 1.0023566E−14 | 2.4705734E−15 |
| A14 | 4.2133373E−18 | −2.0676038E−17 | −1.1686807E−15 | −4.8293247E−16 |
| A15 | −2.4007236E−19 | 3.0462267E−20 | −1.3109310E−18 | −1.2535261E−18 |
| A16 | 2.5850059E−22 | 1.7395503E−20 | 1.6577512E−18 | 6.6434774E−19 |
| A17 | 1.0941265E−22 | −7.6096779E−24 | −1.5480638E−20 | −5.2298303E−22 |
| A18 | −9.9779945E−25 | −8.3378159E−24 | −1.0190733E−21 | −5.0128259E−22 |
| A19 | −1.9056780E−26 | 1.5876715E−28 | 1.2975974E−23 | 5.6638051E−25 |
| A20 | 2.5903023E−28 | 1.7346216E−27 | 1.4566400E−25 | 1.6240563E−25 |

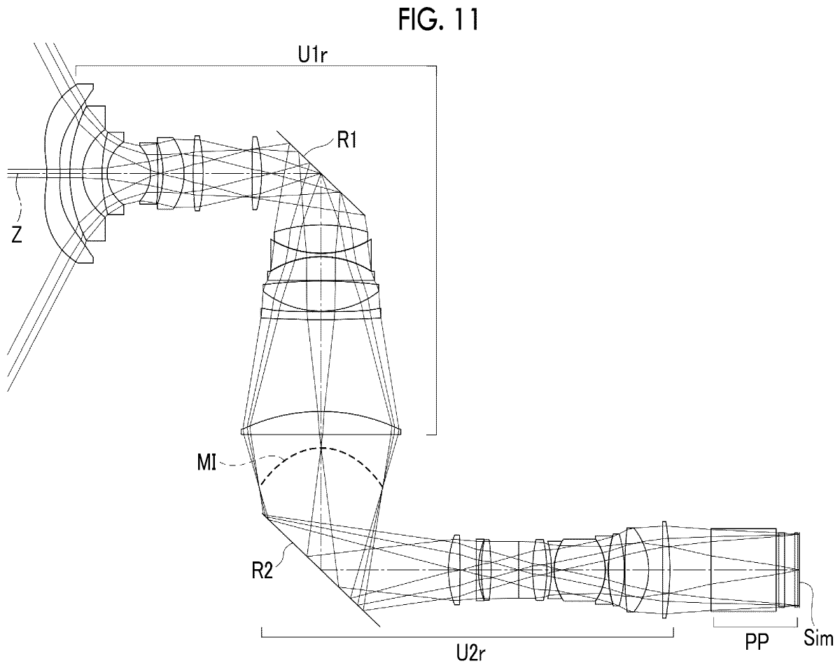

FIG. 11 shows a configuration and luminous fluxes of a modification example of the zoom lens according to Example 3 at the wide angle end. The zoom lens of FIG. 11 includes two optical path banding numbers, and thus the optical path is bent twice. The zoom lens of FIG. 11 consists of a first optical system U1r and a second optical system U2r along the optical path in order from the enlargement side to the reduction side. The first optical system U1r of FIG. 11 is different from the first optical system U1 according to Example 3 in that a mirror R1 is disposed in the first optical system U1r and bents the optical path. The second optical system U2r of FIG. 11 is different from the second optical system U2 according to Example 3 in that a mirror R2 is disposed in the second optical system U2r closest to the enlargement side and bents the optical path. The other configurations of the zoom lens of FIG. 11 are the same as those of the zoom lens according to Example 3.

### Example 4

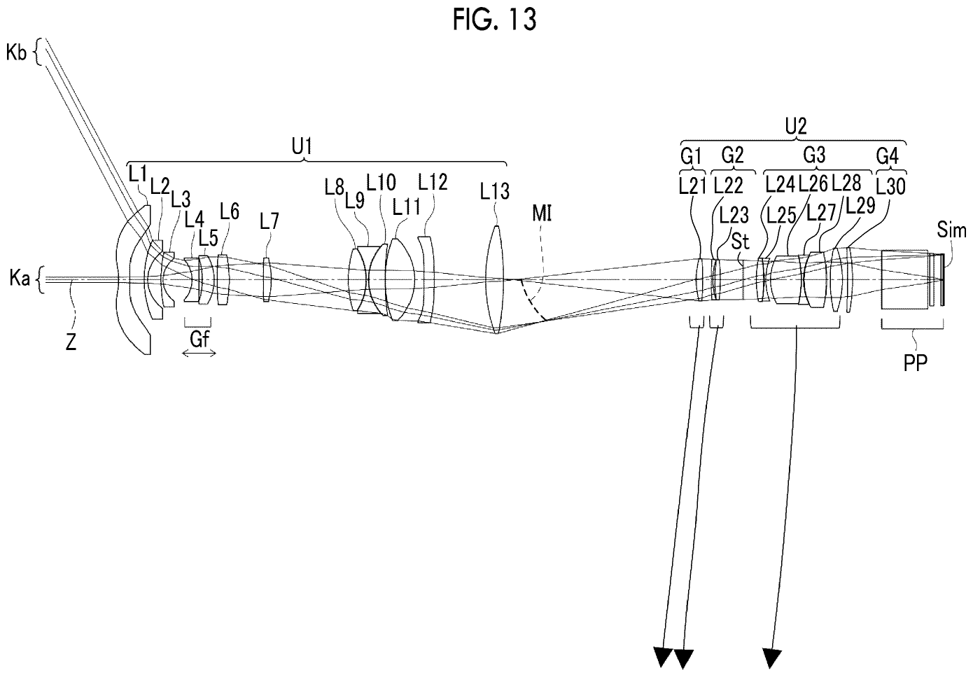

FIG. 13 is a cross-sectional view showing a configuration and luminous fluxes of a zoom lens according to Example 4 at the wide angle end. The zoom lens according to Example 4 consists of the first optical system U1 having a positive refractive power and the second optical system U2 in order from the enlargement side to the reduction side. The first optical system U1 consists of the lenses L1 to L13 in order from the enlargement side to the reduction side. The second optical system U2 consists of the first lens group G1, the second lens group G2, the third lens group G3, and the fourth lens group G4 in order from the enlargement side to the reduction side. The first lens group G1 consists of the lens L21. The second lens group G2 consists of the lenses L22 and L23 and the aperture stop St in order from the enlargement side to the reduction side. The third lens group G3 consists of the lenses L24 to L29 in order from the enlargement side to the reduction side. The fourth lens group G4 consists of the lens L30.

During changing magnification, each of the first lens group G1, the second lens group G2, and the third lens group G3 moves along the optical axis Z while changing a spacing to an adjacent group. During changing magnification, each of the first optical system U1 and the fourth lens group G4 is fixed to the reduction-side imaging plane. The focusing group Gf consists of the lenses L4 and L5.

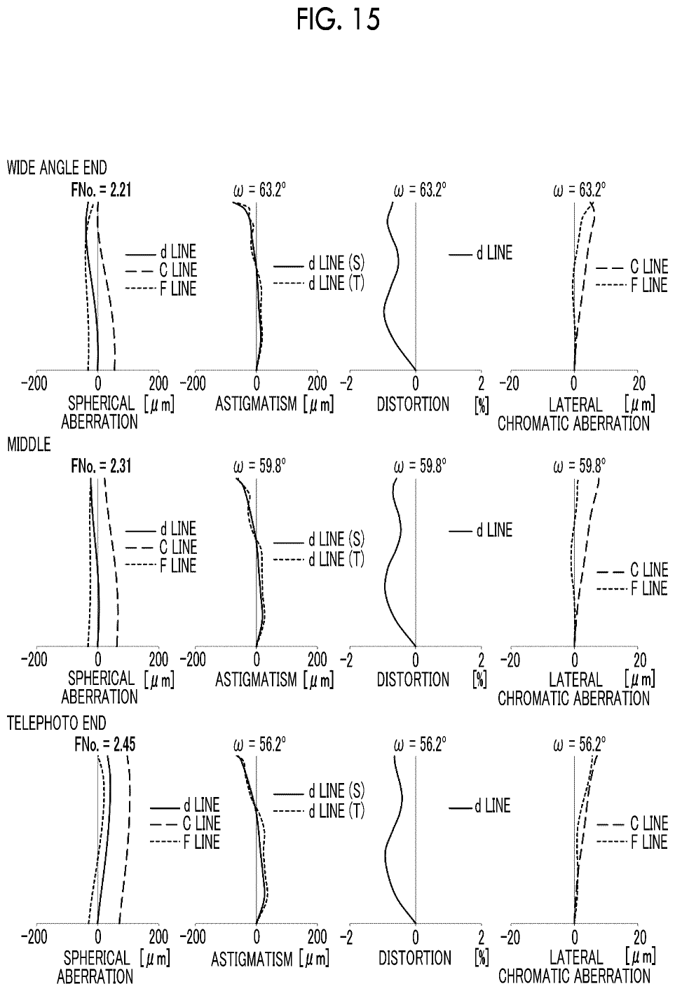

Regarding the zoom lens according to Example 4, Tables 10A and 10B show basic lens data, Table 11 shows specifications and variable surface spacings, Table 12 shows aspherical coefficients, and FIG. 15 shows each of aberration diagrams. The basic lens data, the specifications, and each of the aberration diagrams are those in a state where the projection distance is 0.97 meters (m).

TABLE 10A
Example 4

| Sn | R | D | Nd | vd | ED |
|---|---|---|---|---|---|
| *1 | −26.6529 | 5.6998 | 1.53638 | 56.09 | |
| *2 | −76.1620 | 6.9483 | | | |
| 3 | 54.5684 | 1.7839 | 1.80518 | 25.46 | 41.64 |
| 4 | 18.6434 | 6.6755 | | | |
| 5 | 72.0863 | 1.0657 | 1.68893 | 31.07 | |
| 6 | 14.2069 | 14.2961 | | | |
| 7 | −16.4644 | 3.5944 | 1.49700 | 81.61 | |
| 8 | −267.5781 | 1.5644 | | | |
| 9 | −37.9885 | 5.9389 | 1.80420 | 46.50 | |
| 10 | −25.3715 | 1.5664 | | | |
| 11 | 174.7017 | 6.0009 | 1.80518 | 25.46 | |
| 12 | −67.7440 | 16.5440 | | | |
| 13 | 221.0695 | 4.0930 | 1.59282 | 68.62 | |
| 14 | −47.2036 | 38.4827 | | | |
| 15 | 55.0252 | 8.7874 | 1.49700 | 81.61 | |
| 16 | −31.7874 | 1.2000 | 1.92286 | 20.88 | |
| 17 | 27.7970 | 8.3000 | 1.60311 | 60.64 | |
| 18 | 142.6925 | 0.1008 | | | |
| 19 | 66.1343 | 14.5921 | 1.49700 | 81.61 | |
| 20 | −31.3826 | 4.7145 | | | |
| *21 | −584.1365 | 5.0819 | 1.51633 | 64.06 | |
| *22 | −155.2865 | 25.7614 | | | |
| 23 | 86.6404 | 8.9318 | 1.84666 | 23.78 | 58.29 |
| 24 | −165.9083 | DD[24] | | | |

TABLE 10B
Example 4

| Sn | R | D | Nd | vd |
|---|---|---|---|---|
| 25 | 45.2472 | 3.2182 | 1.69680 | 55.46 |
| 26 | −199.3141 | DD[26] | | |
| 27 | 215.1467 | 0.8000 | 1.94595 | 17.98 |
| 28 | 33.2404 | 1.0672 | | |
| 29 | 77.3436 | 2.6750 | 1.83481 | 42.72 |
| 30 | −107.9454 | DD[30] | | |
| 31(St) | ∞ | 6.5339 | | |
| 32 | 62.0961 | 3.6124 | 1.92286 | 20.88 |
| 33 | −82.8788 | 0.2102 | | |
| 34 | −65.3386 | 0.9008 | 1.83481 | 42.72 |
| 35 | 32.5876 | 2.3576 | | |
| 36 | 26.1515 | 15.4150 | 1.49700 | 81.61 |
| 37 | −58.6052 | 0.1010 | | |
| 38 | −55.2811 | 1.0963 | 1.83481 | 42.72 |
| 39 | 30.4253 | 0.3239 | | |
| 40 | 33.4543 | 11.1344 | 1.49700 | 81.61 |
| 41 | −71.9896 | 1.7185 | | |
| 42 | 77.3957 | 6.1595 | 1.51680 | 64.20 |
| 43 | −51.2127 | DD[43] | | |
| 44 | −707.1473 | 2.6698 | 1.94595 | 17.98 |
| 45 | −95.0801 | 14.5050 | | |
| 46 | ∞ | 23.0000 | 1.51680 | 64.20 |
| 47 | ∞ | 1.0000 | | |
| 48 | ∞ | 2.0000 | 1.52300 | 58.76 |
| 49 | ∞ | 3.5800 | | |
| 50 | ∞ | 1.1000 | 1.50997 | 61.61 |
| 51 | ∞ | 0.5129 | | |

TABLE 11
Example 4

| | Wide Angle End | Middle | Telephoto End |
|---|---|---|---|
| Zr | 1.00 | 1.15 | 1.33 |
| \|f\| | 6.66 | 7.66 | 8.83 |
| F No. | 2.21 | 2.31 | 2.45 |
| 2ω[°] | 126.4 | 119.6 | 112.4 |
| DD[24] | 96.0330 | 86.9090 | 78.0208 |
| DD[26] | 4.3178 | 6.1756 | 7.4956 |
| DD[30] | 11.1668 | 12.5317 | 12.0496 |
| DD[43] | 2.3984 | 8.2993 | 16.3502 |

TABLE 12
Example 4

| Sn | 1 | 2 | 21 | 22 |
|---|---|---|---|---|
| KA | 3.1181324E−01 | 1.4836360E+00 | 1.0000000E+00 | 1.0000000E+00 |
| A3 | −2.4902654E−05 | 1.6094785E−04 | 0.0000000E+00 | 0.0000000E+00 |
| A4 | 1.6133420E−04 | 9.0630262E−05 | −5.6482967E−06 | 8.1425149E−06 |
| A5 | −6.2492399E−06 | 3.3059833E−06 | −2.1663989E−06 | −4.8280638E−06 |
| A6 | −2.8692150E−07 | −8.2855476E−07 | 7.7295658E−07 | 1.3000477E−06 |
| A7 | 2.4044959E−08 | 2.1604716E−08 | −5.6625551E−08 | −8.1853458E−08 |
| A8 | 9.3452703E−11 | 1.9485071E−09 | −4.5088396E−09 | −8.5961737E−09 |
| A9 | −4.7606987E−11 | −1.1136864E−10 | 6.1374807E−10 | 1.1910821E−09 |
| A10 | 7.4404097E−13 | −1.9909358E−12 | 3.5567792E−12 | −8.0484144E−12 |
| A11 | 4.7235518E−14 | 2.5037889E−13 | −2.6849205E−12 | −5.1173580E−12 |
| A12 | −1.3714310E−15 | −6.5719116E−16 | 4.6338738E−14 | 2.1415857E−13 |
| A13 | −2.2429533E−17 | −3.0666279E−16 | 6.2692095E−15 | 7.6513754E−15 |
| A14 | 1.0743289E−18 | 3.5576663E−18 | −1.8484551E−16 | −6.9243402E−16 |
| A15 | 3.0289124E−21 | 2.1416398E−19 | −8.2096745E−18 | 4.0899538E−18 |
| A16 | −4.2681698E−22 | −3.4628848E−21 | 3.1156993E−19 | 8.4942130E−19 |
| A17 | 1.1771636E−24 | −8.0418789E−23 | 5.6947346E−21 | −2.1943629E−20 |
| A18 | 8.0830282E−26 | 1.4876346E−24 | −2.5601476E−22 | −2.3501077E−22 |
| A19 | −3.3944757E−28 | 1.2619771E−26 | −1.6303355E−24 | 1.5917235E−23 |
| A20 | −5.2001826E−30 | −2.4625994E−28 | 8.3872303E−26 | −1.7514063E−25 |

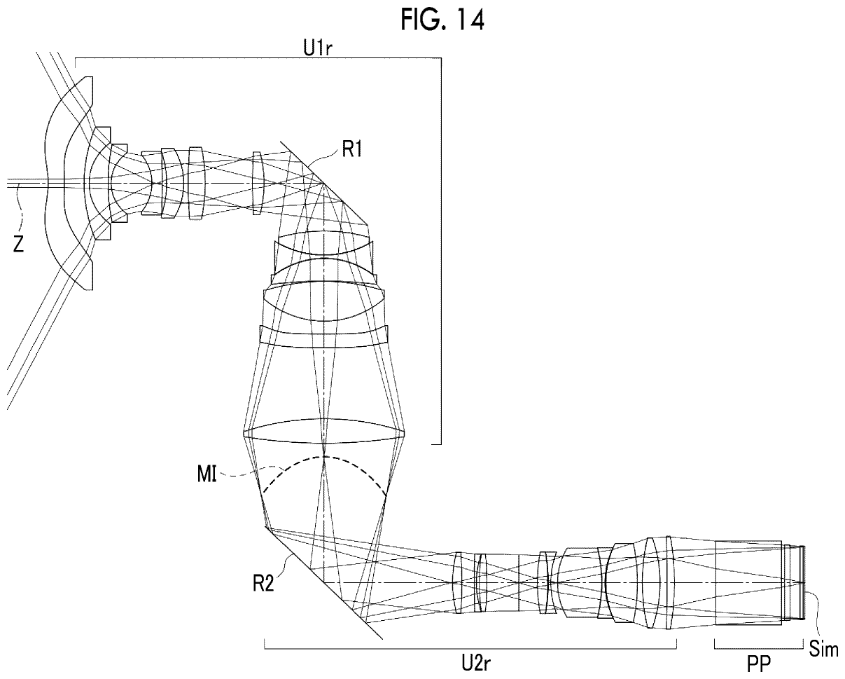

FIG. 14 shows a configuration and luminous fluxes of a modification example of the zoom lens according to Example 4 at the wide angle end. The zoom lens of FIG. 14 includes two optical path banding numbers, and thus the optical path is bent twice. The zoom lens of FIG. 14 consists of a first optical system U1r and a second optical system U2r along the optical path in order from the enlargement side to the reduction side. The first optical system U1r of FIG. 14 is different from the first optical system U1 according to Example 4 in that a mirror R1 is disposed in the first optical system U1r and bents the optical path. The second optical system U2r of FIG. 14 is different from the second optical system U2 according to Example 4 in that a mirror R2 is disposed in the second optical system U2r closest to the enlargement side and bents the optical path. The other configurations of the zoom lens of FIG. 14 are the same as those of the zoom lens according to Example 4.

### Example 5

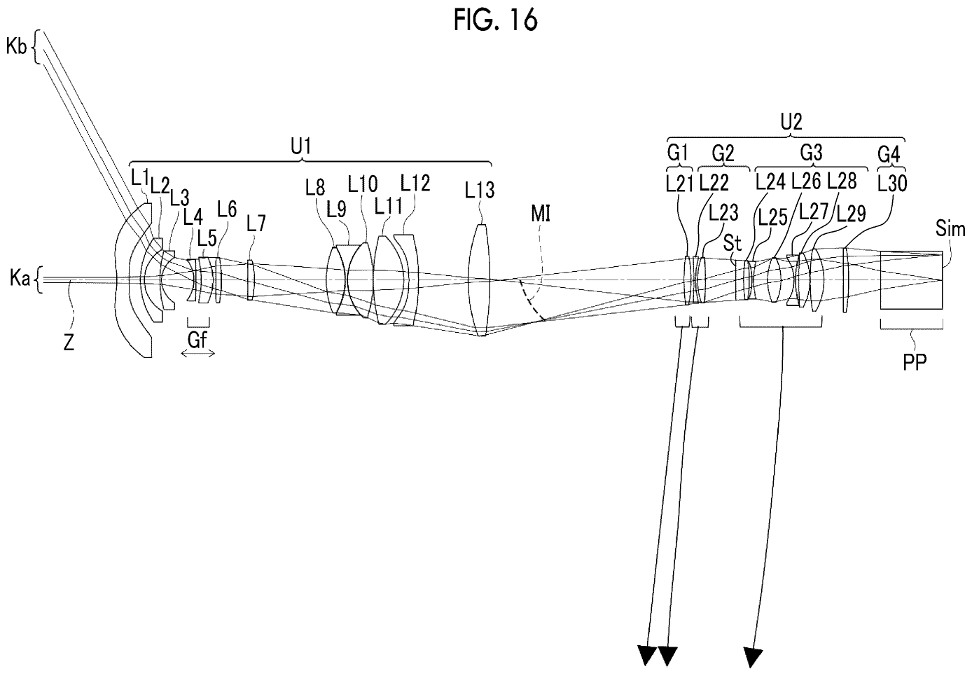

FIG. 16 is a cross-sectional view showing a configuration and luminous fluxes of a zoom lens according to Example 5 at the wide angle end. The zoom lens according to Example 5 consists of the first optical system U1 having a positive refractive power and the second optical system U2 in order from the enlargement side to the reduction side. The first optical system U1 consists of the lenses L1 to L13 in order from the enlargement side to the reduction side. The second optical system U2 consists of the first lens group G1, the second lens group G2, the third lens group G3, and the fourth lens group G4 in order from the enlargement side to the reduction side. The first lens group G1 consists of the lens L21. The second lens group G2 consists of the lenses L22 and L23 and the aperture stop St in order from the enlargement side to the reduction side. The third lens group G3 consists of the lenses L24 to L29 in order from the enlargement side to the reduction side. The fourth lens group G4 consists of the lens L30.

During changing magnification, each of the first lens group G1, the second lens group G2, and the third lens group G3 moves along the optical axis Z while changing a spacing to an adjacent group. During changing magnification, each of the first optical system U1 and the fourth lens group G4 is fixed to the reduction-side imaging plane. The focusing group Gf consists of the lenses L4 and L5.

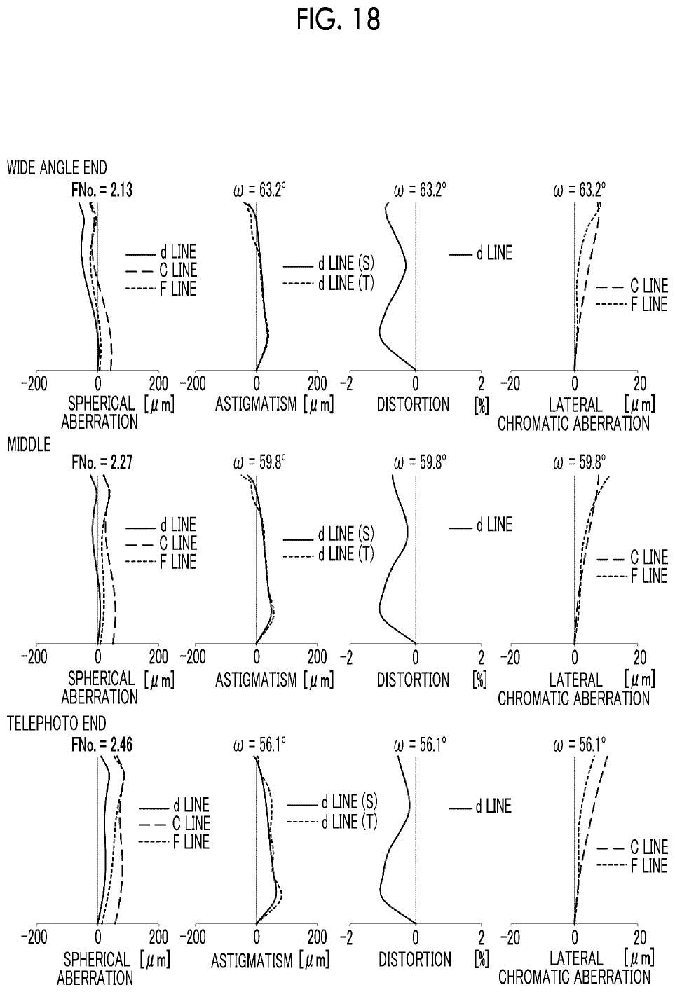

Regarding the zoom lens according to Example 5, Tables 13A and 13B show basic lens data, Table 14 shows specifications and variable surface spacings, Table 15 shows aspherical coefficients, and FIG. 18 shows each of aberration diagrams. The basic lens data, the specifications, and each of the aberration diagrams are those in a state where the projection distance is 0.97 meters (m).

TABLE 13A
Example 5

| Sn | R | D | Nd | vd | ED |
|---|---|---|---|---|---|
| *1 | −30.5974 | 6.1506 | 1.53097 | 55.66 | |
| *2 | −133.6602 | 5.5376 | | | |
| 3 | 39.6197 | 1.9999 | 1.92286 | 20.88 | 43.67 |
| 4 | 19.2083 | 7.5628 | | | |
| 5 | 58.4623 | 0.7991 | 1.75500 | 52.32 | |
| 6 | 14.0497 | 16.1887 | | | |
| 7 | −17.6429 | 0.9667 | 1.49700 | 81.61 | |
| 8 | −221.7347 | 2.6094 | | | |
| 9 | −49.3203 | 5.8092 | 1.84666 | 23.78 | |
| 10 | −28.5710 | 1.2964 | | | |
| 11 | 283.0708 | 2.7994 | 1.87070 | 40.73 | |
| 12 | −77.4008 | 13.1280 | | | |
| 13 | 318.0722 | 3.3585 | 1.59282 | 68.62 | |
| 14 | −42.0369 | 35.3903 | | | |
| 15 | 46.2458 | 9.3493 | 1.49700 | 81.61 | |
| 16 | −35.4974 | 1.2009 | 1.92286 | 20.88 | |
| 17 | 27.9061 | 12.8165 | 1.55052 | 75.50 | |
| 18 | −67.1251 | 0.0294 | | | |
| 19 | 94.5500 | 15.0000 | 1.49700 | 81.61 | |
| 20 | −33.5302 | 2.6110 | | | |
| *21 | −57.1498 | 4.7148 | 1.51633 | 64.06 | |
| *22 | −200.0007 | 24.6418 | | | |
| 23 | 87.8087 | 10.5012 | 1.84666 | 23.78 | 59.81 |
| 24 | −192.5737 | DD[24] | | | |

TABLE 13B
Example 5

| Sn | R | D | Nd | vd |
|---|---|---|---|---|
| 25 | 97.6584 | 3.2705 | 1.59282 | 68.62 |
| 26 | −79.6246 | DD[26] | | |
| 27 | −252.4864 | 0.8010 | 1.92286 | 20.88 |
| 28 | 48.1528 | 1.0116 | | |
| 29 | 38.0586 | 3.9073 | 1.75500 | 52.32 |
| 30 | −146.2989 | DD[30] | | |
| 31(St) | ∞ | 3.8897 | | |
| 32 | 78.1403 | 2.8688 | 1.92286 | 20.88 |
| 33 | −66.3501 | 1.2735 | | |
| 34 | −31.5778 | 0.7993 | 1.87070 | 40.73 |
| 35 | 39.5191 | 6.9165 | | |
| 36 | 29.7407 | 6.7212 | 1.49700 | 81.61 |
| 37 | −28.7314 | 6.4829 | | |
| 38 | −20.7585 | 0.8000 | 1.69680 | 55.46 |
| 39 | 55.5518 | 1.4016 | | |
| 40 | 210.6301 | 5.6168 | 1.49700 | 81.61 |
| 41 | −30.6256 | 0.0298 | | |
| 42 | 101.8635 | 6.9360 | 1.49700 | 81.61 |
| 43 | −33.6986 | DD[43] | | |
| 44 | −1479.8255 | 2.6116 | 1.94595 | 17.98 |
| 45 | −115.9308 | 15.7284 | | |
| 46 | ∞ | 30.6464 | 1.51633 | 64.14 |
| 47 | ∞ | 0.0000 | | |

TABLE 14
Example 5

| | Wide Angle End | Middle | Telephoto End |
|---|---|---|---|
| Zr | 1.00 | 1.15 | 1.33 |
| \|f\| | 6.66 | 7.66 | 8.85 |
| F No. | 2.13 | 2.27 | 2.46 |
| 2ω[°] | 126.4 | 119.6 | 112.2 |
| DD[24] | 96.1903 | 85.5297 | 75.0513 |
| DD[26] | 1.4997 | 5.2259 | 6.0281 |
| DD[30] | 15.0328 | 15.8256 | 17.3766 |
| DD[43] | 9.6740 | 15.8155 | 23.9408 |

TABLE 15
Example 5

| Sn | 1 | 2 | 21 | 22 |
|---|---|---|---|---|
| KA | −6.8154789E−02 | 1.0000090E+00 | 1.0000000E+00 | 1.0000000E+00 |
| A3 | 1.2552791E−04 | 5.3708771E−04 | 0.0000000E+00 | 0.0000000E+00 |
| A4 | 9.3624713E−05 | −2.8974385E−05 | −4.7586440E−05 | −3.2332070E−05 |
| A5 | −1.1005330E−06 | 1.1429637E−05 | 7.7013605E−06 | 5.1389845E−06 |
| A6 | −3.1810833E−07 | −4.1418990E−07 | −1.2434843E−07 | 3.2824931E−07 |
| A7 | 9.1398870E−09 | −4.6557386E−08 | −1.2124328E−07 | −1.3673139E−07 |
| A8 | 5.8911721E−10 | 2.0751758E−09 | 9.2337332E−09 | 5.1368346E−09 |
| A9 | −2.8483981E−11 | 1.4183687E−10 | 4.8888258E−10 | 9.0720630E−10 |
| A10 | −3.8993822E−13 | −7.1249023E−12 | −7.3872867E−11 | −6.9270150E−11 |
| A11 | 3.9032933E−14 | −2.4295555E−13 | 2.1363790E−13 | −2.1621970E−12 |
| A12 | −1.0462616E−16 | 1.4039895E−14 | 2.6469854E−13 | 3.3580012E−13 |
| A13 | −2.8675382E−17 | 2.4526185E−16 | −7.1813846E−15 | −1.8846324E−15 |
| A14 | 3.0866308E−19 | −1.6588248E−17 | −4.6944769E−16 | −7.9848002E−16 |
| A15 | 1.1834398E−20 | −1.3980941E−19 | 2.2713909E−17 | 2.0577653E−17 |
| A16 | −1.8793391E−22 | 1.1580881E−20 | 3.0480777E−19 | 8.4504501E−19 |
| A17 | −2.5933787E−24 | 3.9597032E−23 | −3.1077864E−20 | −3.9565975E−20 |
| A18 | 5.1138446E−26 | −4.3950551E−24 | 1.8416798E−22 | −8.8503153E−23 |
| A19 | 2.3509553E−28 | −3.8788823E−27 | 1.6407105E−23 | 2.5538741E−23 |
| A20 | −5.4041684E−30 | 6.9851371E−28 | −2.6673433E−25 | −3.3436631E−25 |

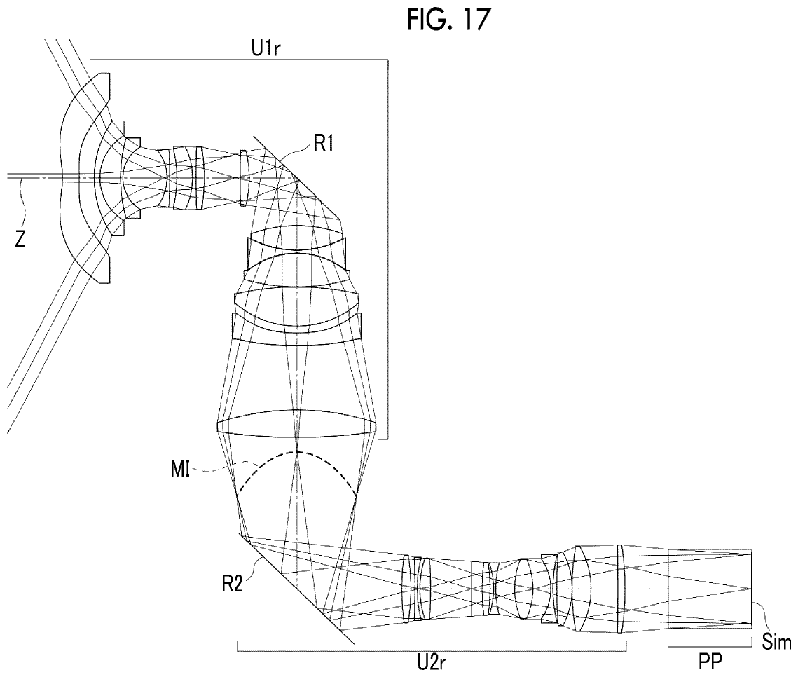

FIG. 17 shows a configuration and luminous fluxes of a modification example of the zoom lens according to Example 5 at the wide angle end. The zoom lens of FIG. 17 includes two optical path banding numbers, and thus the optical path is bent twice. The zoom lens of FIG. 17 consists of a first optical system U1r and a second optical system U2r along the optical path in order from the enlargement side to the reduction side. The first optical system U1r of FIG. 17 is different from the first optical system U1 according to Example 5 in that a mirror R1 is disposed in the first optical system U1r and bents the optical path. The second optical system U2r of FIG. 17 is different from the second optical system U2 according to Example 5 in that a mirror R2 is disposed in the second optical system U2r closest to the enlargement side and bents the optical path. The other configurations of the zoom lens of FIG. 17 are the same as those of the zoom lens according to Example 5.

### Example 6

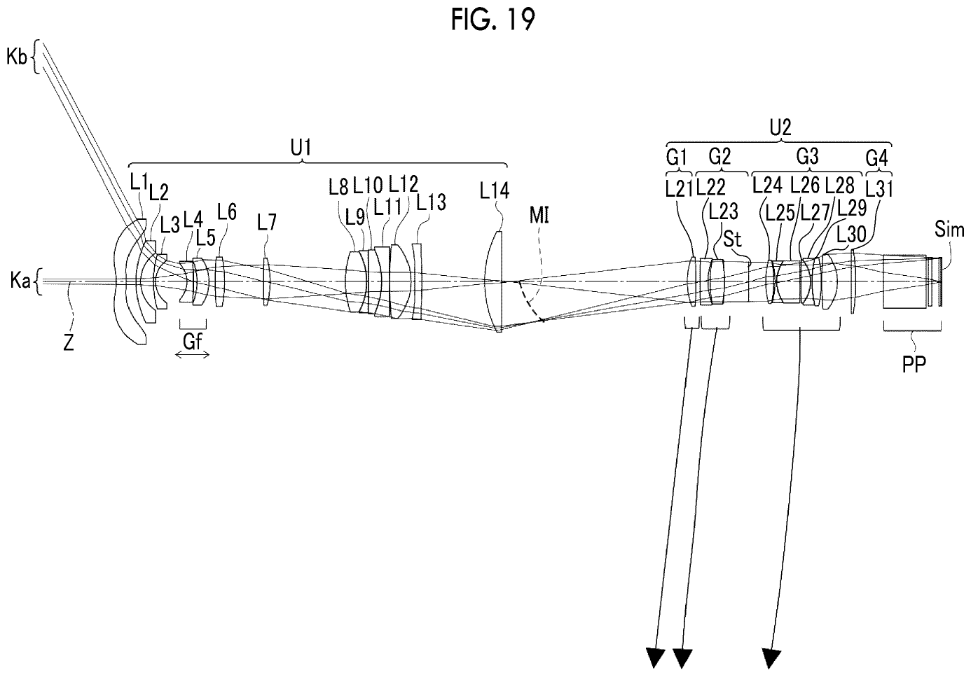

FIG. 19 is a cross-sectional view showing a configuration and luminous fluxes of a zoom lens according to Example 6 at the wide angle end. The zoom lens according to Example 6 consists of the first optical system U1 having a positive refractive power and the second optical system U2 in order from the enlargement side to the reduction side. The first optical system U1 consists of lenses L1 to L14 in order from the enlargement side to the reduction side. The second optical system U2 consists of the first lens group G1, the second lens group G2, the third lens group G3, and the fourth lens group G4 in order from the enlargement side to the reduction side. The first lens group G1 consists of the lens L21. The second lens group G2 consists of the lenses L22 and L23 and the aperture stop St in order from the enlargement side to the reduction side. The third lens group G3 consists of lenses L24 to L30 in order from the enlargement side to the reduction side. The fourth lens group G4 consists of a lens L31.

During changing magnification, each of the first lens group G1, the second lens group G2, and the third lens group G3 moves along the optical axis Z while changing a spacing to an adjacent group. During changing magnification, each of the first optical system U1 and the fourth lens group G4 is fixed to the reduction-side imaging plane. The focusing group Gf consists of the lenses L4 and L5.

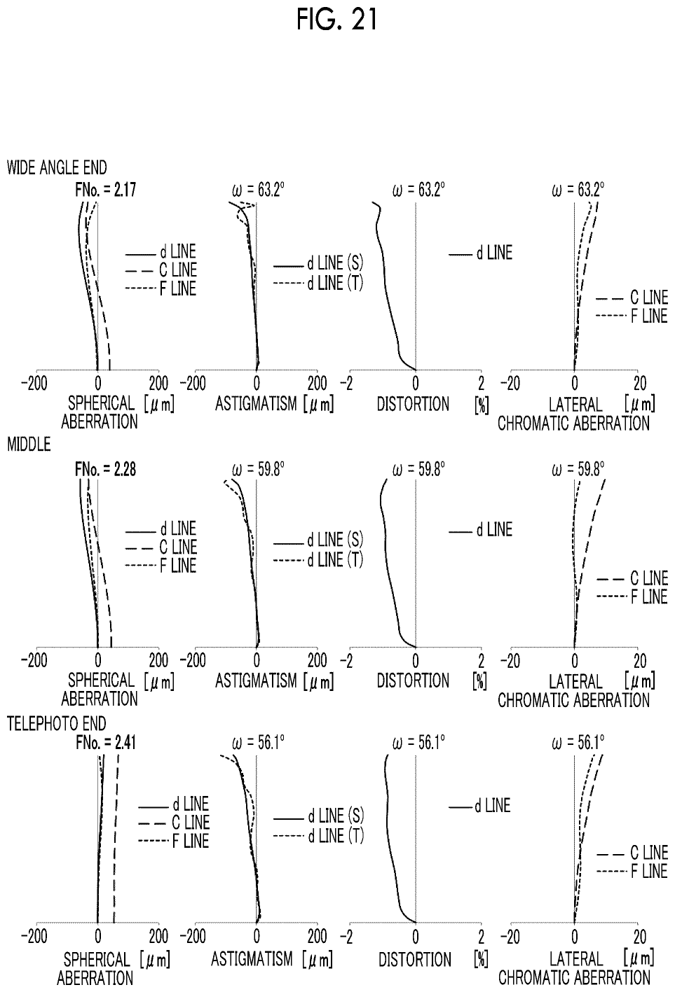

Regarding the zoom lens according to Example 6, Tables 16A and 16B show basic lens data, Table 17 shows specifications and variable surface spacings, Table 18 shows aspherical coefficients, and FIG. 21 shows each of aberration diagrams. The basic lens data, the specifications, and each of the aberration diagrams are those in a state where the projection distance is 0.97 meters (m).

TABLE 16A
Example 6

| Sn | R | D | Nd | vd | ED |
|---|---|---|---|---|---|
| *1 | −29.0532 | 5.3386 | 1.53638 | 56.09 | |
| *2 | −79.9394 | 5.0871 | | | |
| 3 | 52.7063 | 2.4343 | 1.83481 | 42.72 | 46.16 |
| 4 | 20.2314 | 6.9098 | | | |
| 5 | 57.3614 | 1.1007 | 1.86966 | 20.02 | |
| 6 | 14.8512 | 16.6200 | | | |
| 7 | −15.7458 | 3.5291 | 1.48749 | 70.44 | |
| 8 | −124.5580 | 1.8729 | | | |
| 9 | −32.7482 | 6.3565 | 1.80420 | 46.50 | |
| 10 | −24.0632 | 3.3660 | | | |
| 11 | 154.1897 | 4.9705 | 1.80518 | 25.46 | |
| 12 | −75.3289 | 20.3881 | | | |
| 13 | 587.9725 | 3.5313 | 1.59282 | 68.62 | |
| 14 | −53.4359 | 40.0000 | | | |
| 15 | 53.7341 | 11.1444 | 1.49700 | 81.61 | |
| 16 | −37.8455 | 0.1243 | | | |
| 17 | −36.8788 | 0.7991 | 1.94595 | 17.98 | |
| 18 | 4533.0001 | 0.2606 | | | |
| 19 | −806.6420 | 6.9544 | 1.59282 | 68.62 | |
| 20 | −43.2670 | 0.0100 | | | |
| 21 | −43.1716 | 4.0288 | 1.94595 | 17.98 | |
| 22 | 1931.1970 | 0.2009 | | | |
| 23 | 223.8074 | 11.3535 | 1.49700 | 81.61 | |
| 24 | −33.6608 | 1.9130 | | | |
| *25 | −598.7779 | 3.7787 | 1.51633 | 64.06 | |
| *26 | −175.6697 | 33.5459 | | | |
| 27 | 63.0622 | 8.9981 | 1.84666 | 23.78 | 56.55 |
| 28 | ∞ | DD[28] | | | |

TABLE 16B
Example 6

| Sn | R | D | Nd | vd |
|---|---|---|---|---|
| 29 | 39.7690 | 4.5132 | 1.60311 | 60.64 |
| 30 | −273.4720 | DD[30] | | |
| 31 | 559.3311 | 4.1529 | 1.94595 | 17.98 |
| 32 | 35.0507 | 1.1785 | | |
| 33 | 63.3478 | 7.3954 | 1.83481 | 42.72 |
| 34 | −117.6016 | 12.6957 | | |
| 35(St) | ∞ | DD[35] | | |
| 36 | 50.4868 | 4.4027 | 1.92286 | 20.88 |
| 37 | −53.8113 | 0.6495 | | |
| 38 | −46.9648 | 0.9000 | 1.83481 | 42.72 |
| 39 | 21.0283 | 0.0333 | | |
| 40 | 21.1827 | 12.1814 | 1.48749 | 70.44 |
| 41 | −4929.4525 | 0.7267 | | |
| 42 | 601.3870 | 5.0210 | 1.49700 | 81.61 |
| 43 | −20.3710 | 0.0690 | | |
| 44 | −20.1254 | 0.7991 | 1.83481 | 42.72 |
| 45 | 57.4921 | 0.0301 | | |
| 46 | 58.5221 | 4.9447 | 1.49700 | 81.61 |
| 47 | −63.3450 | 0.2000 | | |
| 48 | 170.1351 | 8.2335 | 1.51680 | 64.20 |
| 49 | −25.6462 | DD[491] | | |
| 50 | ∞ | 2.4995 | 1.94595 | 17.98 |
| 51 | −115.0806 | 14.5000 | | |
| 52 | ∞ | 23.0000 | 1.51680 | 64.20 |
| 53 | ∞ | 1.0000 | | |
| 54 | ∞ | 2.0000 | 1.52300 | 58.76 |
| 55 | ∞ | 3.5800 | | |
| 56 | ∞ | 1.1000 | 1.50997 | 61.61 |
| 57 | ∞ | 0.5669 | | |

TABLE 17
Example 6

| | Wide Angle End | Middle | Telephoto End |
|---|---|---|---|
| Zr | 1.00 | 1.15 | 1.33 |
| \|f\| | −6.69 | −7.67 | −8.89 |
| F No. | 2.17 | 2.28 | 2.41 |
| 2ω[°] | 126.4 | 119.6 | 112.2 |
| DD[28] | 98.6603 | 88.6687 | 78.3892 |
| DD[30] | 2.3269 | 3.9415 | 4.8224 |
| DD[35] | 9.1898 | 11.1858 | 11.6034 |
| DD[49] | 7.3491 | 13.7222 | 22.7122 |

TABLE 18
Example 6

| Sn | 1 | 2 | 25 | 26 |
|---|---|---|---|---|
| KA | −9.5888388E−02 | −3.0482600E−01 | 1.0000000E+00 | 1.0000000E+00 |
| A3 | −4.7632367E−04 | −3.1760027E−04 | 0.0000000E+00 | 0.0000000E+00 |
| A4 | 2.4698954E−04 | 1.7053489E−04 | 1.2247879E−05 | 2.1385171E−05 |
| A5 | −1.3741619E−05 | 1.1236045E−07 | −3.8922985E−06 | −3.2756236E−06 |
| A6 | −2.2580655E−07 | −1.4373052E−06 | 4.3425218E−07 | 2.4472909E−07 |
| A7 | 5.2710518E−08 | 6.6422618E−08 | −2.8430189E−11 | 1.9832580E−08 |
| A8 | −1.1350545E−09 | 4.9346498E−09 | −3.5943946E−09 | −3.2398550E−09 |
| A9 | −8.7137274E−11 | −4.2035870E−10 | 1.2975001E−10 | −5.8174091E−11 |
| A10 | 4.1620473E−12 | −7.1951451E−12 | 1.2252871E−11 | 1.7982035E−11 |
| A11 | 4.6469450E−14 | 1.3060374E−12 | −5.3884480E−13 | 2.0792801E−13 |
| A12 | −5.7498202E−15 | −5.1804032E−15 | −2.7515254E−14 | −6.8480875E−14 |
| A13 | 3.5713607E−17 | −2.2597509E−15 | 7.9852379E−16 | −5.8668308E−16 |
| A14 | 3.9377808E−18 | 3.3646610E−17 | 6.1305412E−17 | 1.7685949E−16 |
| A15 | −5.8627388E−20 | 2.2081976E−18 | −2.3414850E−19 | 7.7020917E−19 |
| A16 | −1.3183591E−21 | −4.7932263E−20 | −1.1558627E−19 | −2.7939140E−19 |
| A17 | 2.7568845E−23 | −1.1369962E−21 | −4.5238790E−22 | −2.8264463E−22 |
| A18 | 1.6998554E−25 | 3.0247534E−23 | 1.2363841E−22 | 2.3859057E−22 |
| A19 | −4.4914096E−27 | 2.3926214E−25 | 3.0730935E−25 | −1.0327253E−25 |
| A20 | −5.8678447E−31 | −7.3208456E−27 | −5.2494263E−26 | −8.4118127E−26 |

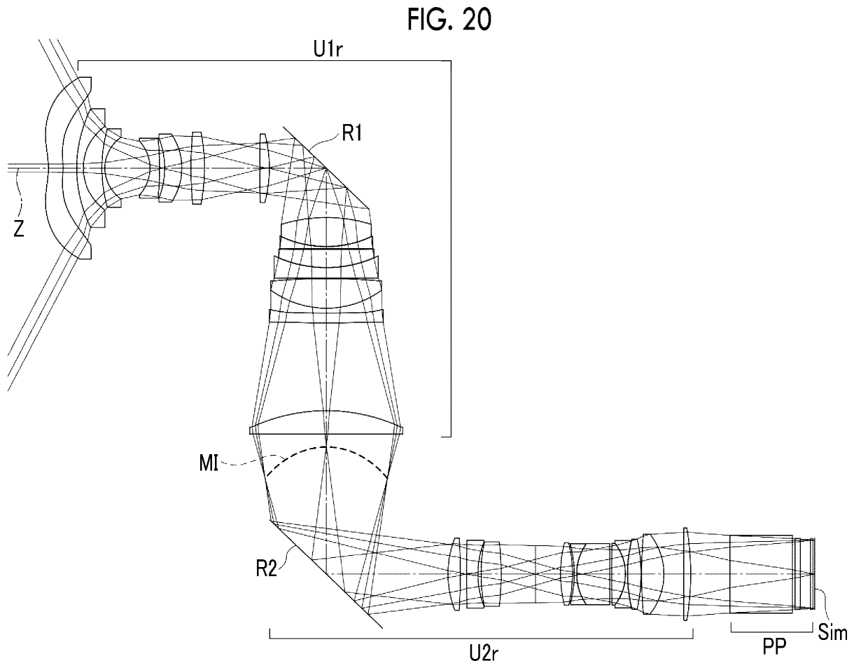

FIG. 20 shows a configuration and luminous fluxes of a modification example of the zoom lens according to Example 6 at the wide angle end. The zoom lens of FIG. 20 includes two optical path banding numbers, and thus the optical path is bent twice. The zoom lens of FIG. 20 consists of a first optical system U1r and a second optical system U2r along the optical path in order from the enlargement side to the reduction side. The first optical system U1r of FIG. 20 is different from the first optical system U1 according to Example 6 in that a mirror R1 is disposed in the first optical system U1r and bents the optical path. The second optical system U2r of FIG. 20 is different from the second optical system U2 according to Example 6 in that a mirror R2 is disposed in the second optical system U2r closest to the enlargement side and bents the optical path. The other configurations of the zoom lens of FIG. 20 are the same as those of the zoom lens according to Example 6.

In the above description, in Examples 2 to 6, an example where the optical path is bent twice is shown as a modification example. However, for Examples 2 to 6, a modification example of the configuration including only the first optical path bending member as the optical path bending member and a modification example of the configuration including only the second optical path bending member as the optical path bending member can be made.

Table 19 shows corresponding values of Conditional Expressions (1) to (4) of the zoom lenses according to Examples 1 to 6. Preferable ranges of the conditional expressions may be set by using the corresponding values of the examples shown in Table 19 as the upper limits or the lower limits of the conditional expressions.

TABLE 19

| | | Ex- | Ex- | Ex- | Ex- | Ex- | Ex- |
|---|---|---|---|---|---|---|---|
| | | am- | am- | am- | am- | am- | am- |
| Expression | Condition | ple | ple | ple | ple | ple | ple |
| No. | Expression | 1 | 2 | 3 | 4 | 5 | 6 |
| (1) | fr1/\|fw\| | 1.86 | 1.86 | 1.88 | 1.88 | 1.93 | 1.89 |
| (2) | \|f1/f2\| | 0.21 | 0.08 | 0.32 | 0.27 | 0.20 | 0.24 |
| (3) | \|f3/f2 | 0.25 | 0.10 | 0.43 | 0.37 | 0.19 | 0.32 |
| (4) | f1/f3 | 0.85 | 0.80 | 0.74 | 0.72 | 1.04 | 0.77 |

The zoom lenses according to Examples 1 to 6 have a high magnification which is a zoom magnification of 1.2 times or more. The zoom lenses of Examples 1 to 6 have a wide angle of view which is a total angle of view of 105 degrees or more at the wide angle end. Further, in the zoom lenses of Examples 1 to 6, a variation in aberrations during changing magnification is suppressed, and each aberration is satisfactorily corrected to achieve high optical performance.

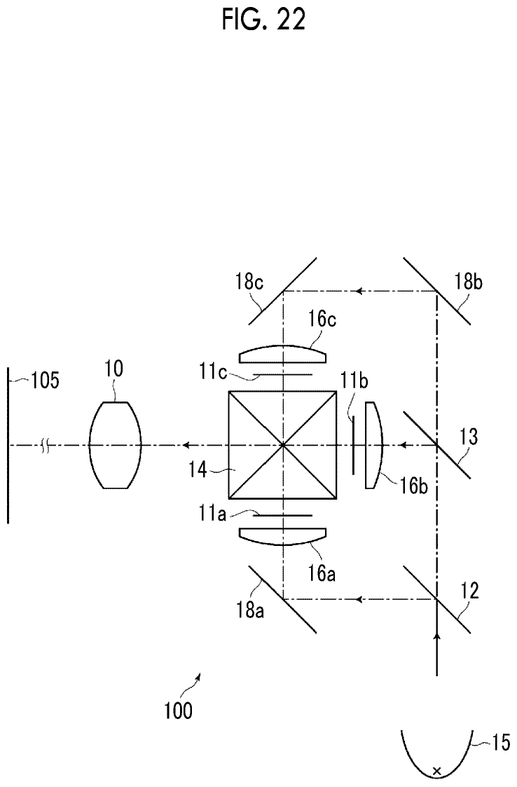

Next, a projection type display device according to an embodiment of the present disclosure will be described. FIG. 22 is a schematic configuration diagram showing the projection type display device according to the embodiment of the present disclosure. A projection type display device 100 shown in FIG. 22 includes a zoom lens 10 according to an embodiment of the present disclosure, a light source 15, and transmissive display elements 11a to 11c as light valves corresponding to colored rays and outputting optical images. Further, the projection type display device 100 includes dichroic mirrors 12 and 13 for color separation, a cross dichroic prism 14 for color synthesis, condenser lenses 16a to 16c, and total reflection mirrors 18a to 18c for deflecting the optical path. It should be noted that FIG. 22 schematically shows the zoom lens 10. Further, an integrator is disposed between the light source 15 and the dichroic mirror 12, but is not shown in FIG. 22.

White light emitted from the light source 15 is separated into three colored luminous fluxes (blue light, green light, and red light) through the dichroic mirrors 12 and 13. Next, the three colored luminous fluxes pass through the condenser lenses 16a to 16c, are incident on and modulated by the transmissive display elements 11a to 11c respectively corresponding to the respective colored luminous fluxes, are subjected to color synthesis by the cross dichroic prism 14, and are subsequently incident on the zoom lens 10. The zoom lens 10 projects an optical image based on the modulated light modulated by the transmissive display elements 11a to 11c onto a screen 105.

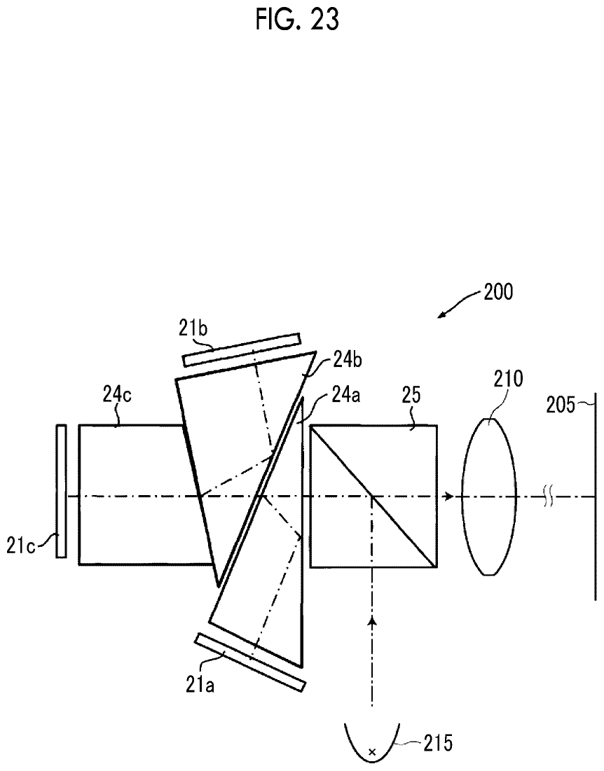

FIG. 23 is a schematic configuration diagram showing a projection type display device according to another embodiment of the present disclosure. A projection type display device 200 shown in FIG. 23 includes a zoom lens 210 according to an embodiment of the present disclosure, a light source 215, and digital micromirror device (DMD: registered trademark) elements 21a to 21c as light valves corresponding to respective colored rays and outputting optical images. Further, the projection type display device 200 includes total internal reflection (TIR) prisms 24a to 24c for color separation and color synthesis, and a polarization separating prism 25 that separates illumination light and projection light. It should be noted that FIG. 23 schematically shows the zoom lens 210. In addition, an integrator is disposed between the light source 215 and the polarization separating prism 25, but is not shown in FIG. 23.

White light emitted from the light source 215 is reflected from a reflecting surface inside the polarization separating prism 25, and is separated into three colored luminous fluxes (blue light, green light, and red light) by the TIR prisms 24a to 24c. The separated colored luminous fluxes are respectively incident on and modulated by the corresponding DMD elements 21a to 21c, travel through the TIR prisms 24a to 24c again in the opposite direction, are subjected to color synthesis, subsequently transmit through the polarization separating prism 25, and are incident on the zoom lens 210. The zoom lens 210 projects an optical image based on the modulated light modulated by the DMD elements 21a to 21c onto a screen 205.

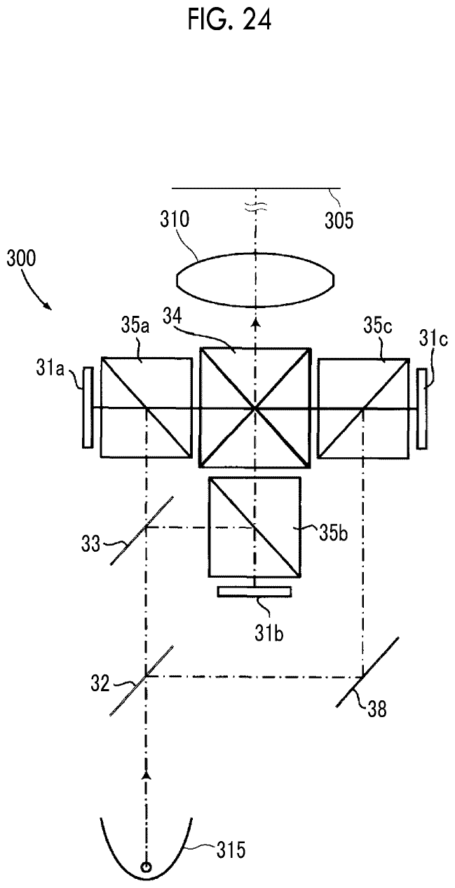

FIG. 24 is a schematic configuration diagram showing a projection type display device according to still another embodiment of the present disclosure. A projection type display device 300 shown in FIG. 24 includes a zoom lens 310 according to an embodiment of the present disclosure, a light source 315, and reflective display elements 31a to 31c as light valves corresponding to colored rays and outputting optical images. In addition, the projection type display device 300 includes dichroic mirrors 32 and 33 for color separation, a cross dichroic prism 34 for color synthesis, a total reflection mirror 38 for optical path deflection, and polarization separating prisms 35a to 35c. It should be noted that FIG. 24 schematically shows the zoom lens 310. Further, an integrator is disposed between the light source 315 and the dichroic mirror 32, but is not shown in FIG. 24.

White light emitted from the light source 315 is separated into three colored luminous fluxes (blue light, green light, and red light) through the dichroic mirrors 32 and 33. The separated colored luminous fluxes respectively pass through the polarization separating prisms 35a to 35c, are respectively incident on and modulated by the corresponding reflective display elements 31a to 31c, are subjected to color synthesis by the cross dichroic prism 34, and are subsequently incident on the zoom lens 310. The zoom lens 310 projects an optical image based on the modulated light modulated by the reflective display elements 31a to 31c onto a screen 305.

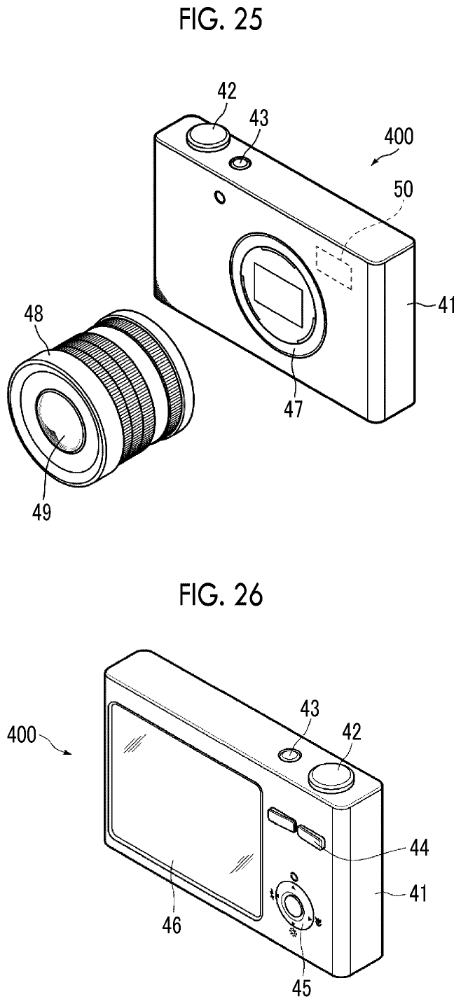

FIGS. 25 and 26 are external views showing a camera 400 that is an imaging apparatus according to an embodiment of the present disclosure. FIG. 25 is a perspective view showing the camera 400 when seen from a front side, and FIG. 26 is a perspective view showing the camera 400 when seen from a rear side. The camera 400 is a mirrorless single-lens type digital camera on which an interchangeable lens 48 is attachably and detachably mounted. The interchangeable lens 48 is a lens barrel containing a zoom lens 49 according to an embodiment of the present disclosure.

The camera 400 includes a camera body 41, and a shutter button 42 and a power button 43 are provided on an upper surface of the camera body 41. Further, an operator 44, an operator 45 and a display unit 46 are provided on the rear surface of the camera body 41. The display unit 46 displays a captured image and an image within an angle of view before imaging.

An imaging aperture through which light from an imaging target is incident is provided at the center on the front surface of the camera body 41. A mount 47 is provided at a position corresponding to the imaging aperture. The interchangeable lens 48 is mounted on the camera body 41 with the mount 47 interposed therebetween.

An imaging element 50 is provided in the camera body 41. The imaging element 50 outputs an imaging signal corresponding to the subject image formed by the interchangeable lens 48. For example, a charge coupled device (CCD) or a complementary metal oxide semiconductor (CMOS) is used as the imaging element 50. A signal processing circuit (not shown), a recording medium (not shown), and the like are provided in the camera body 41. The signal processing circuit processes the imaging signal output from the imaging element 50 to generate an image. The recording medium is used to record the generated image. The camera 400 captures a still image or a motion picture by pressing the shutter button 42, and records image data obtained through imaging in the recording medium.

The present disclosed technology has been hitherto described through the embodiments and the examples, but the present disclosed technology is not limited to the above-described embodiments and examples, and may be modified into various forms. For example, the curvature radius, the surface spacing, the refractive index, the Abbe number, the aspherical coefficient, and the like of each of the lenses are not limited to the values shown in the examples, and different values may be used therefor.

Further, the projection type display device according to the present disclosed technology is not limited to the above-described configuration, and may be modified into various forms such as the optical member used for luminous flux separation or luminous flux synthesis and the light valve. The light valve is not limited to a form in which light emitted from the light source is spatially modulated by an image display element and is output as an optical image based on image data, but may be a form in which light itself output from a light emitting image display element is output as an optical image based on the image data. Examples of the light emitting image display element include an image display element where light emitting elements such as light emitting diodes (LED) or organic light emitting diodes (OLED) are two-dimensionally arranged.

Further, an imaging apparatus according to the present disclosed technology is not limited to the above-described configuration, and may be modified into various forms such as a non-mirrorless type camera, a film camera, a video camera, a security camera, and a camera for movie imaging.

Regarding the above-described embodiments and examples, the following supplementary notes will be further disclosed.

### Supplementary Note 1

A zoom lens consisting of a first optical system and a second optical system along an optical path in order from an enlargement side to a reduction side,
in which the second optical system forms an intermediate image at a position conjugate to a reduction-side imaging plane, and the first optical system re-forms the intermediate image on an enlargement-side imaging plane,
a lens closest to the enlargement side in the second optical system is a positive lens that has a convex surface facing the enlargement side,
in a case where one lens group is a group of which a spacing to an adjacent group in an optical axis direction changes during changing magnification,
the second optical system includes, continuously along the optical path in order from a position closest to the enlargement side to the reduction side, a first movable lens group having a positive refractive power that moves during changing magnification, a second movable lens group that moves during changing magnification, and a third movable lens group having a positive refractive power that moves during changing magnification, and
in the entire zoom lens, lens groups that move during changing magnification are only the first movable lens group, the second movable lens group, and the third movable lens group.

### Supplementary Note 2

The zoom lens according to Supplementary Note 1,
in which the second optical system includes a stationary lens group that is fixed to the reduction-side imaging plane closest to the reduction side during changing magnification.

### Supplementary Note 3

The zoom lens according to Supplementary Note 2,
in which the stationary lens group has a positive refractive power.

### Supplementary Note 4

The zoom lens according to Supplementary Note 2 or 3,
in which the reduction side is configured to be telecentric.

### Supplementary Note 5

The zoom lens according to any one of Supplementary Notes 1 to 4,
in which the second movable lens group has a negative refractive power.

### Supplementary Note 6

The zoom lens according to any one of Supplementary Notes 1 to 5,
in which in a case where a focal length of the zoom lens at a wide angle end is represented by fw and
a focal length of the first optical system is represented by fr1, Conditional Expression (1) represented by

$$0.8 < fr 1 / \vert fw \vert < 5 \qquad ( 1 )$$

is satisfied.

### Supplementary Note 7

The zoom lens according to any one of Supplementary Notes 1 to 6,
in which the first optical system includes a cemented lens where a positive lens, a negative lens, and a positive lens are cemented in this order.

### Supplementary Note 8

The zoom lens according to any one of Supplementary Notes 1 to 7,
in which an effective diameter of an enlargement-side surface of a second lens from the enlargement side in the first optical system at a wide angle end is less than an effective diameter of an enlargement-side surface of a lens closest to the reduction side in the first optical system at the wide angle end.

### Supplementary Note 9

The zoom lens according to any one of Supplementary Notes 1 to 8,
in which the second movable lens group consists of one negative lens and one positive lens.

### Supplementary Note 10

The zoom lens according to any one of Supplementary Notes 1 to 9,
in which in a case where a focal length of the first movable lens group is represented by f1,
a focal length of the second movable lens group is represented by f2, and
a focal length of the third movable lens group is represented by f3,

Conditional Expressions (2) and (3) represented by

$$0 < \vert f 1 / f 2 \vert < 0.75 and \qquad ( 2 )$$

$$0 < \vert f 3 / f 2 \vert < 0.75 \qquad ( 3 )$$

are satisfied.

### Supplementary Note 11

The zoom lens according to Supplementary Note 10,
in which Conditional Expressions (2-2) and (3-2) represented by

$$0 < \vert f 1 / f 2 \vert < 0.5 and \qquad ( 2 ‐ 2 )$$

$$0 < \vert f 3 / f 2 \vert < 0.5 \qquad ( 3 ‐ 2 )$$

are satisfied.

### Supplementary Note 12

The zoom lens according to any one of Supplementary Notes 1 to 11,
in which in a case where a focal length of the first movable lens group is represented by f1 and
a focal length of the third movable lens group is represented by f3,

Conditional Expression (4) represented by

$$0.5 < f 1 / f 3 < 2 \qquad ( 4 )$$

is satisfied.

### Supplementary Note 13

The zoom lens according to any one of Supplementary Notes 1 to 12,
in which the first movable lens group at a telephoto end is positioned closer to the enlargement side than the first movable lens group at a wide angle end,
the second movable lens group at the telephoto end is positioned closer to the enlargement side than the second movable lens group at the wide angle end, and
the third movable lens group at the telephoto end is positioned closer to the enlargement side than the third movable lens group at the wide angle end.

### Supplementary Note 14

The zoom lens according to Supplementary Note 13,
in which during changing magnification from the wide angle end to the telephoto end, each of the first movable lens group, the second movable lens group, and the third movable lens group constantly moves to the enlargement side.

### Supplementary Note 15

The zoom lens according to any one of Supplementary Notes 1 to 14,
in which a first optical path bending member that bends the optical path is disposed in the first optical system.

### Supplementary Note 16

The zoom lens according to any one of Supplementary Notes 1 to 14,
in which a second optical path bending member that bends the optical path is disposed closer to the reduction side than the first optical system.

### Supplementary Note 17

The zoom lens according to any one of Supplementary Notes 1 to 14,
in which a first optical path bending member that bends the optical path is disposed in the first optical system, and
a second optical path bending member that bends the optical path is disposed closer to the reduction side than the first optical system.

### Supplementary Note 18

The zoom lens according to any one of Supplementary Notes 1 to 17,
in which the first optical system has a positive refractive power and is fixed to the reduction-side imaging plane during changing magnification, and
the second optical system consists of, along the optical path in order from the enlargement side to the reduction side, the first movable lens group, the second movable lens group, the third movable lens group, and a stationary lens group that is fixed to the reduction-side imaging plane during changing magnification.

### Supplementary Note 19

A projection type display device comprising: the zoom lens according to any one of Supplementary Notes 1 to 18.

### Supplementary Note 20

An imaging apparatus comprising: the zoom lens according to any one of Supplementary Notes 1 to 18.

What is claimed is:

1. A zoom lens consisting of a first optical system and a second optical system along an optical path in order from an enlargement side to a reduction side, wherein:
the second optical system forms an intermediate image at a position conjugate to a reduction-side imaging plane, and the first optical system re-forms the intermediate image on an enlargement-side imaging plane,
a lens closest to the enlargement side in the second optical system is a positive lens that has a convex surface facing the enlargement side,
in a case where one lens group is a group of which a spacing to an adjacent group in an optical axis direction changes during changing magnification,
the second optical system includes, continuously along the optical path in order from a position closest to the enlargement side to the reduction side:
a first movable lens group having a positive refractive power that moves during changing magnification;
a second movable lens group that moves during changing magnification; and
a third movable lens group having a positive refractive power that moves during changing magnification, and
in the entire zoom lens, lens groups that move during changing magnification are only the first movable lens group, the second movable lens group, and the third movable lens group.

2. The zoom lens according to claim 1, wherein the second optical system includes a stationary lens group that is fixed to the reduction-side imaging plane closest to the reduction side during changing magnification.

3. The zoom lens according to claim 2, wherein the stationary lens group has a positive refractive power.

4. The zoom lens according to claim 2, wherein the reduction side is configured to be telecentric.

5. The zoom lens according to claim 1, wherein the second movable lens group has a negative refractive power.

6. The zoom lens according to claim 1, wherein in a case where:
a focal length of the zoom lens at a wide angle end is represented by fw, and
a focal length of the first optical system is represented by fr1,
Conditional Expression (1) is satisfied:
$$0.8 < fr 1 / \vert fw \vert < 5. \qquad ( 1 )$$

7. The zoom lens according to claim 1, wherein the first optical system includes a cemented lens where a positive lens, a negative lens, and a positive lens are cemented in this order.

8. The zoom lens according to claim 1, wherein an effective diameter of an enlargement-side surface of a second lens from the enlargement side in the first optical system at a wide angle end is less than an effective diameter of an enlargement-side surface of a lens closest to the reduction side in the first optical system at the wide angle end.

9. The zoom lens according to claim 1, wherein the second movable lens group consists of one negative lens and one positive lens.

10. The zoom lens according to claim 1, wherein in a case where:
a focal length of the first movable lens group is represented by f1,
a focal length of the second movable lens group is represented by f2, and
a focal length of the third movable lens group is represented by f3,
Conditional Expressions (2) and (3) are satisfied:
$$0 < \vert f 1 / f 2 \vert < 0.75 \qquad ( 2 )$$
$$0 < \vert f 3 / f 2 \vert < 0.75 . \qquad ( 3 )$$

11. The zoom lens according to claim 10, wherein Conditional Expressions (2-2) and (3-2) are satisfied:
$$0 < \vert f 1 / f 2 \vert < 0.5 \qquad ( 2 ‐ 2 )$$
$$0 < \vert f 3 / f 2 \vert < 0.5 . \qquad ( 3 ‐ 2 )$$

12. The zoom lens according to claim 1, wherein in a case where:
a focal length of the first movable lens group is represented by f1, and
a focal length of the third movable lens group is represented by f3,
Conditional Expression (4) is satisfied:
$$0.5 < f 1 / f 3 < 2. \qquad ( 4 )$$

13. The zoom lens according to claim 1, wherein:
the first movable lens group at a telephoto end is positioned closer to the enlargement side than the first movable lens group at a wide angle end,
the second movable lens group at the telephoto end is positioned closer to the enlargement side than the second movable lens group at the wide angle end, and
the third movable lens group at the telephoto end is positioned closer to the enlargement side than the third movable lens group at the wide angle end.

14. The zoom lens according to claim 13, wherein during changing magnification from the wide angle end to the telephoto end, each of the first movable lens group, the second movable lens group, and the third movable lens group constantly moves to the enlargement side.

15. The zoom lens according to claim 1, wherein a first optical path bending member that bends the optical path is disposed in the first optical system.

16. The zoom lens according to claim 1, wherein a second optical path bending member that bends the optical path is disposed closer to the reduction side than the first optical system.

17. The zoom lens according to claim 1, wherein:
a first optical path bending member that bends the optical path is disposed in the first optical system, and
a second optical path bending member that bends the optical path is disposed closer to the reduction side than the first optical system.

18. The zoom lens according to claim 1, wherein:
the first optical system has a positive refractive power and is fixed to the reduction-side imaging plane during changing magnification, and
the second optical system consists of, along the optical path in order from the enlargement side to the reduction side, the first movable lens group, the second movable lens group, the third movable lens group, and a stationary lens group that is fixed to the reduction-side imaging plane during changing magnification.

19. A projection type display device comprising the zoom lens according to claim 1.

20. An imaging apparatus comprising: the zoom lens according to claim 1.
